(19) United States
(12) Patent Application Publication
(10) Pub. No.: US 2011/0140706 A1
(43) Pub. Date: Jun. 16, 2011

(54) Particle-Based Electrostatic Sensing and Detection

(76) Inventors: John T. Groves, (US); Nathaniel G. Clack, (US); Khalid S. Salaita, (US); Hung-Jen Wu, (US)

(21) Appl. No.: 12/939,088

(22) Filed: Nov. 3, 2010

Related U.S. Application Data
(63) Continuation of application No. PCT/US2009/043196, filed on May 7, 2009.

(51) Int. Cl. G01N 27/60; G01D 7/02

(52) U.S. Cl. 324/452; 73/866.3

(57) ABSTRACT

An apparatus and methods for electrostatic-based sensing and detection of charges and charged materials displayed on a surface. In a general embodiment, a method for electrostatically sensing charges or charged materials by comparing the electrostatic interaction between a capture surface and a reference surface. Assays to detect binding or interactions between a capture surface and a material to be detected are also described. We also describe a sensitive and label-free electrostatic readout of DNA or RNA hybridization in a microarray format and using a microfluidic device. The electrostatic properties of the hybridized particles are measured using the positions and motions of charged microspheres. This approach enables sensitive, non-destructive electrostatic imaging. Changes in surface charge density as a result of specific molecular interaction can be detected and quantified with great sensitivity, and in the presence of a complex background.

### CROSS-REFERENCE TO RELATED APPLICATIONS

This application claims priority to U.S. Provisional Patent Application No. 61/126,905, filed on May 7, 2008, and International Patent Application PCT/US09/043196, filed on May 7, 2009, both of which are hereby incorporated by reference in their entirety for all purposes.

### STATEMENT OF GOVERNMENTAL SUPPORT

This invention was made with government support under Contract No. DE-AC02-05CH11231 awarded by the U.S. Department of Energy. The government has certain rights in the invention.

### REFERENCE TO SEQUENCE LISTING

This application incorporates by reference the attached sequence listing in paper form.

### BACKGROUND OF THE INVENTION

1. Field of the Invention

The present invention relates to electrostatic imaging and electrostatic-based sensing, measurement and detection of charges and charged materials displayed on a surface.

2. Related Art

Effective medical care is often limited by the failure to diagnose diseases in resource-limited settings. For example, tuberculosis kills 2 million people each year, and according to the 2006 Global Health Diagnostics Forum, 400,000 lives could be saved if a rapid and accurate diagnostic requiring minimal instrumentation were available (Global Health Diagnostics, F. The right tools can save lives. Nature 444, 681-681 (2006)). DNA microarray-based assays promise rapid on-site identification of multiple pathogens, which is particularly important for proper treatment of patients afflicted by multiple diseases or drug-resistant strains of diseases. (Barken, K. B., Haagensen, J. A. J. & Tolker-Nielsen, T. Advances in nucleic acid-based diagnostics of bacterial infections. Clinica Chimica Acta 384, 1-11 (2007), Aitman, T. J. Science, medicine, and the future: DNA microarrays in medical practice. BMJ 323, 611-615 (2001)). However, microarray assays typically rely on fluorescence detection, which requires time-consuming and costly chemical labeling, reverse transcription, high-power excitation sources, and sophisticated instrumentation for scanning. Consequently, microarray assays tend to be performed by a few dedicated centers rather than individual labs, and especially not by clinics in developing countries. Many label-free DNA detection techniques such as surface plasmon resonance, electrochemical sensing, fluorescent polymers, atomic force microscopy, microcantilevers, and electronic depletion of a field effect transistor (FET) have been introduced in efforts to circumvent some of the problems inherent to chemical labeling. However, none of these have gained widespread use because each requires either complex device fabrication or sophisticated instrumentation for readout. Additionally, none are compatible with conventional DNA microarrays where up to one million sequences can be interrogated in a single experiment.

The electrostatic charge of the phosphate backbone provides an intrinsic label, eliminating the need for a chemically coupled reporter group such as a fluorophore. However, electrostatic imaging of a surface is currently carried out using such methods or devices as atomic force microscopy or electrostatic force microscopy. The vertical deflection of an electrostatic force microscope (EFM) tip is used to report local electrostatic surface properties, however, EFM is a serial technique practically limited to a field of view of 100 μm². (Sinensky, A. K. & Belcher, A. M. Label-free and high-resolution protein//DNA nanoarray analysis using Kelvin probe force microscopy. Nat Nano 2, 653-659 (2007); Butt, H. J., Capella, B. & Kappl, M. Force measurements with the atomic force microscope: Technique, interpretation and applications. Surface Science Reports 59, 1-152 (2005)). Thus, there is a need for a technique capable of parallel electrostatic sampling of a surface over centimeter length scales. Furthermore, there is a need for an electrostatic imaging approach compatible with conventional arrays as well as unconventional arrays such as those fabricated on injection-molded plastic or embedded within microfluidic architectures.

### BRIEF SUMMARY OF THE INVENTION

The present invention provides an apparatus and method for electrostatic-based sensing and detection of charges and charged materials displayed on a surface. In a general embodiment, a method for electrostatically sensing charges or charged materials, comprising the steps of (a) providing a capture surface having charges or charged materials to be detected are displayed on said capture surface, (b) providing a reference surface having a reference charge density, (c) allowing the capture surface with the charged reference surface to electrostatically interact; and (d) sensing the charge density of the capture surface by comparison to the charge density of the reference surface.

The capture surface can be of various geometries, including planar, curved, and spherical geometries. In various embodiments, the capture surface is a substantially planar substrate and the reference surface is a particle that may be charged. In another embodiment, the reference surface is a charged planar substrate and the capture surface is a particle.

The capture and reference surfaces can be made from various types and combinations of materials, selected from the group consisting of: any metals, semiconductors, silica, polymers, oxides, fluid interfaces, and biological surfaces. If the capture or reference surface is a particle, said particle being any of the following shape, spherical, rod shaped, triangular, or cubic. If the capture or reference surface is a particle, said particle having a size that range from 1 nm to 200 μm, preferably 500 nm to 100 μm, 0.5 μm to 10 μm, more preferably 1 μm to 6 μm.

In various embodiments, wherein the capture surface is a substantially planar substrate and the reference surface is a particle, the capture surface is glass slide and the reference surface is a particle. In another embodiment, the capture surface is a semiconductor nanocrystal and the reference particle is a metal substrate.

The reference surface should be provided having known, predicted and/or calculated charge densities. The capture and reference surface can be tuned such that the capture event of the analyte bound to the substrate and background are distinguished. The capture surface can be uncharged, or positively or negatively charged. The capture and reference surface are tuned to a total charge density of about 10 to 10⁶ e/μm².

In various embodiments, the capture surface further comprises a capture molecule or capture material attached thereto and displayed on the capture surface. The attached capture molecule or capture material comprising biomolecules such as nucleotides, polynucletides, peptides, polypeptides, proteins, carbohydrates, and polymers, and/or materials such as inorganic sol gels, metals, catalysts, and small molecule libraries. The capture molecule or capture material is attached to the substrate by any means of attachment including covalent or noncovalent binding, or other interaction.

In one embodiment, step (d) sensing the the charge density of the capture surface is carried out by sensing the capture surface's position or motion relative to the reference surface. The charged reference surface can be characterized by imaging the surface using interferometery, microscopy, darkfield microscopy, surface plasmon microscopy, confocal microscopy, total internal reflection microscopy, epifluorescence microscopy or by the naked eye.

Thus, in another embodiment, method for detecting charge on a surface, comprising the steps of: a) providing a capture surface displaying capture molecules or materials and a charged reference surface, wherein one of the charged reference surface or the capture surface is a planar substrate and the other is a particle; b) applying the capture surface together with the charged reference surface, such that they are allowed to electrostatically interact; and c) determining the positions and motions of the particles relative to the planar substrate at a specific loci to determine the charge density at said loci. The capture and reference surfaces can be made from various types and combinations of materials, including but not limited to, any metals, semiconductors, silica, polymers, oxides, fluid interfaces, and biological surfaces. The capture or reference surface as a particle is contemplated having different geometries such as spherical, rod shaped, triangular, or cubic and sizes that range from 1 nm to 200 μm, preferably 500 nm to 100 μm, 0.5 μm to 10 μm, more preferably 1 μm to 6 μm.

In another embodiment, an assay for detecting the presence of an analyte in a sample, the assay comprising the steps of: a) providing a capture surface displaying capture molecules or materials and a charged reference surface, wherein one of the charged reference surface or the capture surface is a planar substrate and the other is a particle; b) providing a solution suspected of containing an analyte that binds to a specific one of said capture molecules or materials displayed on the capture surface, c) contacting said solution with the capture surface and allowing said binding to occur; d) applying the capture surface and charged reference surface, such that the charged reference surface is allowed to interact with the capture surface; f) characterizing the capture surface electrostatically by examining the positions, motions and/or presence of the particles relative to the planar substrate; and g) determining the presence of the analyte, wherein a change in the charge density of the capture surface indicates that an analyte is present in said sample and bound to said substrate.

And in another embodiment, an assay for detecting a nucleotide or polypeptide in a sample, the assay comprising the steps of: a) providing a capture surface displaying capture sequences and a charged reference surface, wherein one of the charged reference surface or the capture surface is a planar substrate and the other is a particle; b) providing a solution suspected of containing a nucleotide or polypeptide to be detected that binds specifically to one of said capture sequences displayed on the capture surface, c) contacting said solution with the capture surface and allowing said binding to occur; d) applying the capture surface and charged reference surface, such that the two surfaces are allowed to electrostatically interact; f) determining the positions and/or motions of the charged particles relative to the planar substrate to sense the electrostatic properties of the capture surface; and g) determining the presence of the nucleotide or polypeptide, wherein a change in the charge density of the capture surface indicates that the nucleotide or polypeptide is present in said sample and bound to said substrate.

In one aspect, a microfluidic device, comprising: a) a microfluidic channel patterned on a substrate, b) magnetic capture particles disposed in said microfluidic channel, wherein said capture particles displaying capture molecules which can bind to a target, c) a magnet placed on the top of said channel to hold the capture particles in the detection zone of said microfluidic channel, d) electrodes patterned on the substrate such that the electrodes are in contact with the microfluidic channel and connected to a power source for applying an electric field to the capture surface, such that the capture surface migrates in the electric field; and e) imaging means for determining the positions and motions of the particles under the electric field at a specific loci to determine the charge density at said loci.

Another aspect of the invention provides for a method for detecting charge on a surface, comprising the steps of: a) providing a capture surface displaying capture molecules or materials, wherein the capture surface is a particle; b) providing a solution suspected of containing an analyte that binds to a specific one of said capture molecules or materials displayed on the capture surface, c) contacting said solution with the capture surface and allowing said binding to occur; d) applying an electric field to the capture surface, such that the capture surface migrates in the electric field; and e) determining the positions and motions of the particles under the electric field at a specific loci to determine the charge density at said loci. the present invention also provides a method for sensitive and label-free electrostatic readout of DNA or RNA hybridization in a microarray format. The electrostatic properties of the microarray are measured using the positions and motions of charged microspheres randomly dispersed over the surface. This approach enables non-destructive electrostatic imaging with 10 μm lateral resolution over centimeter length-scales, which is four orders of magnitude larger than that practically achievable with conventional scanning electric force microscopy. Changes in surface charge density as a result of specific DNA hybridization can be detected and quantified with 50 pM sensitivity, single base-pair mismatch selectivity, and in the presence of a complex background. Moreover, no more than a magnifying glass is needed to read out the microarray, potentially enabling the broad application of inexpensive genome-scale assays for point-of-care applications.

### BRIEF DESCRIPTION OF THE DRAWINGS

FIG. 1A. Electrostatic sensing and detection using a capture substrate surface and a charged reference particle to determine charge density of the capture surface. FIG. 1B. Electrostatic sensing and detection using a capture particle surface and a charged reference surface to determine charge density of capture surface.

FIG. 2 shows three embodiments of sensing and detection of the capture surface.

FIG. 3. Electrostatic microarray readout using particle probes. (A) A suspension of negatively charged silica microspheres is gravitationally sedimented over a microarray surface. The positions and motions of a population of microspheres are used to image the surface charge of the microarray and detect hybridization. This is because areas displaying double stranded DNA are highly negatively charged compared to areas displaying single stranded DNA, and both contrast with the positively charged background. (B) Typical epifluorescence image of a microspot displaying DNA A after hybridizing with 50 nM Cy3-labelled A′. (C) Brightfield image after 5.6 μm diameter silica microspheres are allowed to gravitationally sediment for 20 min. The dashed line indicates the spot's perimeter as determined by fluorescence. (D) Representative reflection interference contrast microscopy (RICM) image of 5.6 μm diameter silica spheres. Such interferograms are used to measure the height of microspheres, and, consequently, the magnitude of electrostatic repulsion over the surface. (E) The charge density map, as compiled from RICM observations of microspheres (black dots). (F) Over negatively charged areas, microspheres are laterally mobile as indicated by the variance of brightfield intensity over time (pixel size is 3×3 μm). (G) Microspheres that remain adhered after agitating the surface can be observed by darkfield microscopy to identify positively charged regions. Images B-G correspond to the same spot.

FIG. 4 shows electrostatic detection of DNA hybridization by using silica capture particles. Silica particles modified with capture DNA were hybridized with 500 pM (top) and 5 pM (bottom) target DNA (Cy3-labeled). Particles were then allowed to sediment onto a freshly cleaned glass coverslip. Brightfield images (BF) indicate particle locations, whereas fluorescence micrographs confirm hybridization of target. Note that the fluorescence intensity is higher for the 500 pM hybridization compared to the 5 pM hybridization. Particles with dsDNA are more negatively charged compared to ssDNA particles and are therefore, electrostatically repelled by the surface and undergo Brownian motion as indicated by the variance of brightfield intensity collected over a period of 2 min (mobility images). Scheme shows an idealized depiction of hybridized particles

FIG. 5. Electrostatic response to DNA surface density. (A) A graded DNA density was generated by printing spots with a mixture of specific, A, and control, B, DNA while maintaining a constant total DNA concentration (5 or 6 μM as indicated). Charge density and fluorescence images of the same array are shown after hybridization with 50 nM A′. (B) Plot of the average charge density and fluorescence intensity in spots along the 5 μM lane in A. The dashed lines are linear fits. The charge density roughly doubles as the molar fraction of A increases from 0 to 1. This is consistent with the expectation that complimentary DNA binding should double the ssDNA charge density. (C) Electrostatic response of a 2×2 array of A and B DNA to specific hybridization with target DNA A′, B′, or both A′ and B′ strands. (D) Image of SEQ ID NO:5, A₁₂ (5′-TACCACATCATC-3′) and SEQ ID NO:6, A_{12M} (5′-TACCAAATCATC-3′) spots before and after hybridization with 50 nM A′ for 20 min which indicates that electrostatic imaging can resolve a single base-pair mismatch. (E) Epifluorescence and electrostatic images of A and B spots after overnight hybridization with 100 pM A′ DNA. Under these experimental conditions, fluorescence and electrostatic imaging exhibit comparable limits of detection.

FIG. 6. Simplified readout using charged microparticles. (A) A series of microarray spots are printed with a gradient of ssDNA densities to titrate the surface charge from net positive to net negative. After hybridization, complimentary spots become more negatively charged. In each series, the change in DNA density can be identifying by a shift in the number of negatively biased spots relative to a control series. (B) Schematic and experimental data demonstrates this concept. Images of the variance in brightfield intensity over 30 s indicate where sedimented 2.34 μm diameter silica spheres remain mobile. Negatively charged areas appear bright due to the lateral motion of microspheres repelled by the surface. Relative to the control DNA series, B, two additional spots in the AA′ row appear negatively biased, indicating a specific change in charge density due to hybridization. (C) The observed shift is dependent on the concentration of target A′. Plot compares this label-free readout with fluorescence data obtained on the same substrate under identical conditions. Inset points were hybridized overnight, and all others were performed for 20 min. (D) Darkfield and epifluorescence (inverse contrast) micrographs of a representative area from a 7000 spot microarray hybridized (20 min, 50 nM A′). This suggests that this assay is compatible with conventional microarrays that cover cm² areas. (E) Photograph of a side-illuminated microarray after hybridization and development with 2.34 μm diameter silica spheres. Inset, right, shows a digitally magnified region of the array (inverse contrast with subtracted background). Bright areas indicate regions of high DNA density.

FIG. 7. Label-free expression profiling with primary mRNA. (A) Scheme of procedure used to measure mRNA expression in breast adenocarcinoma MCF-7 cells. (B) A brightfield intensity variance image of 2.34 μm silica microspheres shows the differential expression of human aldolase A gene (ALD) and human methionine-tRNA synthetase (MARS) gene in a 4×4 array of spots. This indicates that MARS is more highly expressed compared to ALD in this sample of cells.

FIG. 8. Single-base mismatch detection using simplified readout. A 2×2 array of probe sequences of SEQ ID NO:5, A₁₂ (5′-TACCACATCATC-3′) and SEQ ID NO: 6, A_{12M} (5′-TACCAAATCATC-3′) differing by a single-base was imaged after hybridization with 50 nM A₁₂′ using the variance in brightfield mobility. 2.34 μm diameter silica microparticles were used for readout.

FIG. 9. Multiplexed detection using simplified readout. Fluorescence and Brightfield variance images of a microarray surface after hybridization with 50 nM SEQ ID NO: 7, A₁₂′ (5′-Cy3-GAT GAT GTG GTA-3′). The microarray was printed using a 6×4 array with 24 unique sequences (SEQ ID NOS: 11-34). Hybridization was performed in 1×SSC for 20 min.

FIG. 10. Expected and observed equilibrium heights of 5.6 μm diameter silica spheres as a function of ionic strength (pH 5.5, silica density 1.95 g/cm³). Each data point represents the median height measured from 20 microspheres imaged for 3 min (360 images) using dual-wavelength RICM. The dashed line indicates the dependence predicted from Eqs. 1-2.

FIG. 11. Electrostatically sensing DNA captured on particle surface in multi-channel microfluidic device. (A) The schematics of the microfluidic setup. The microfluidic channel cast in PDMS and the gold electrodes are patterned on the microscope slides. The magnet is placed on the top of channel to hold DNA captured particles with magnetic cores. (B) Top view of the microfluidic setup. The particles with different DNA strands are injected into different parallel channels to provide multiplexed readout. DNA targets are injected into each channel from the left-hand inlet. The magnet is placed on the top of microfluidic channels to hold magnetic particles within the detection zone while the buffer or DNA targets are added. The surface charge changes of particles are determined by monitoring multiple particle migrations in the electric field using conventional microscope and CCD camera. (C) Fluorescent response of complementary and non-complementary DNA observed by epifluorescence microscope. (D) Electrostatic readout of complementary and non-complementary DNA molecules captured by microparticles.

### DETAILED DESCRIPTION OF THE PREFERRED EMBODIMENT

### Introduction

The present invention provides methods and devices for sensing of charges or charged materials displayed on a surface. Sensing of charges and charged materials can further comprise imaging charge density of a surface using charged (e.g., micro or nano-sized) particles. The electrostatic properties of the substrate surface are measured using the positions and motions of these charged particles interacting with the surface. This approach enables non-destructive electrostatic sensing. Changes in surface charge density as a result of specific molecular interaction can be detected and quantified with great sensitivity, and in the presence of a complex background.

### Description of the Embodiments

In one embodiment, the invention provides for electrostatically sensing charges or charged materials displayed on a surface. The charges or charged materials to be detected are displayed on a capture surface, and a reference surface is provided.

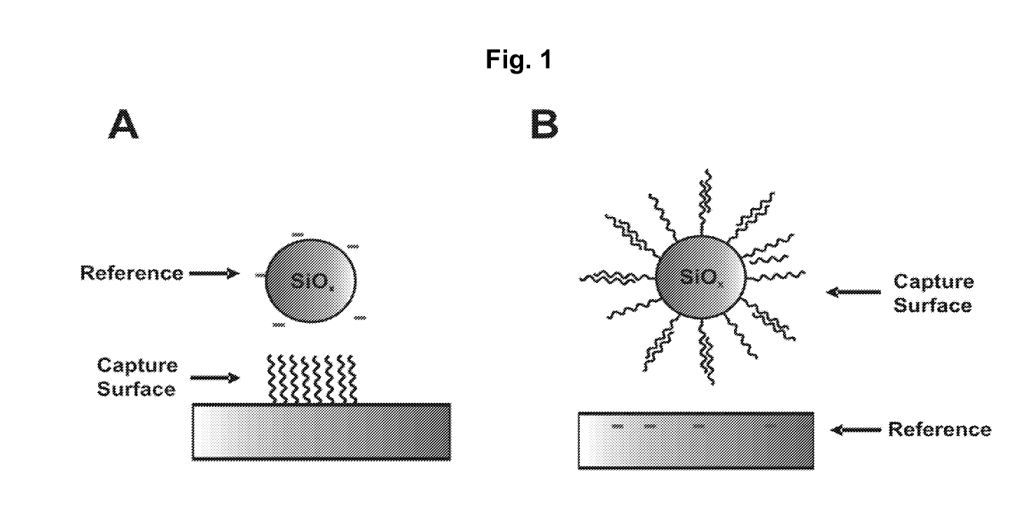

The capture surface can be of various geometries, including planar, curved, and spherical geometries. In one embodiment, the capture surface is a substantially planar substrate and the reference surface is a charged particle. Herein where a substrate is referred to as “planar” it should be understood to mean “substantially planar” as it is contemplated that in some embodiments, the substrate will have some measure of topography. Referring now to FIG. 1A, in a preferred embodiment, the capture surface is a planar substrate and the reference surface is a particle. In another embodiment, as shown in FIG. 1B, the reference surface is a charged planar substrate and the capture surface is a particle.

For example, in one embodiment, the capture surface is a glass slide and the reference surface is a particle. In another example, the capture surface is a semiconductor nanocrystal and the reference particle is a metal substrate.

The capture and reference surfaces can be made from various types and combinations of materials, including but not limited to, any metals, semiconductors, silica, polymers, oxides, fluid interfaces, and biological surfaces. The capture or reference surface as a particle is contemplated having different geometries such as spherical, rod shaped, triangular, or cubic and sizes that range from 1 nm to 200 μm, preferably 500 nm to 100 μm, 0.5 μm to 10 μm, more preferably 1 μm to 6 μm.

As used herein, the term “particle” is meant to include particles of various size and shape. Sizes of particles can range, for example, from 1 nm to 200 μm. Particles can have different geometries including but not limited to, spherical, rod shaped, triangular, or cubic, and comprising various types of materials including but not limited to, silica, polymers, metals, metal oxides, semiconductors or other materials with known catalytic properties. Charged particles can be either positively or negatively charged.

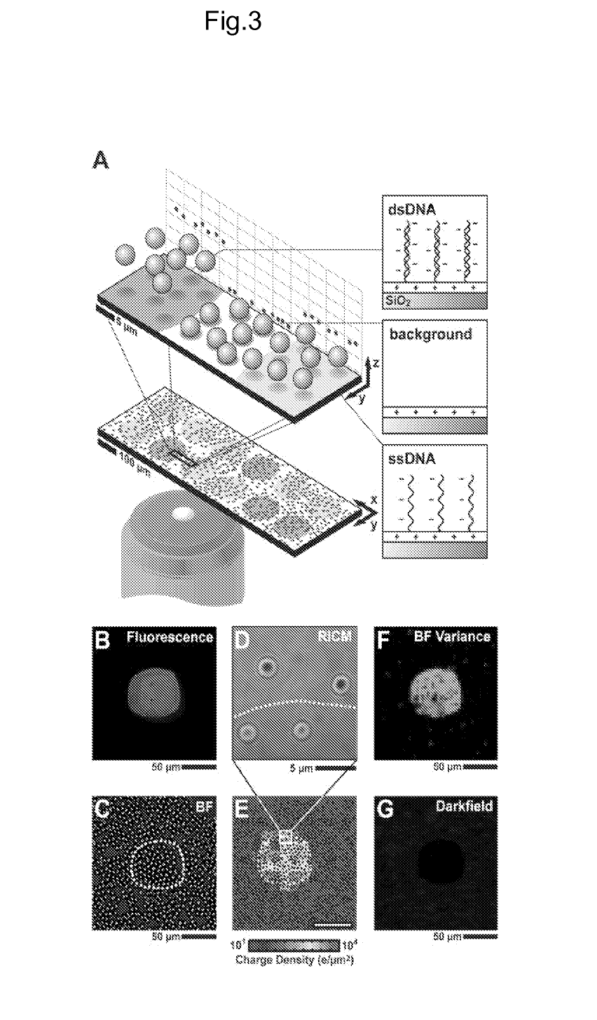

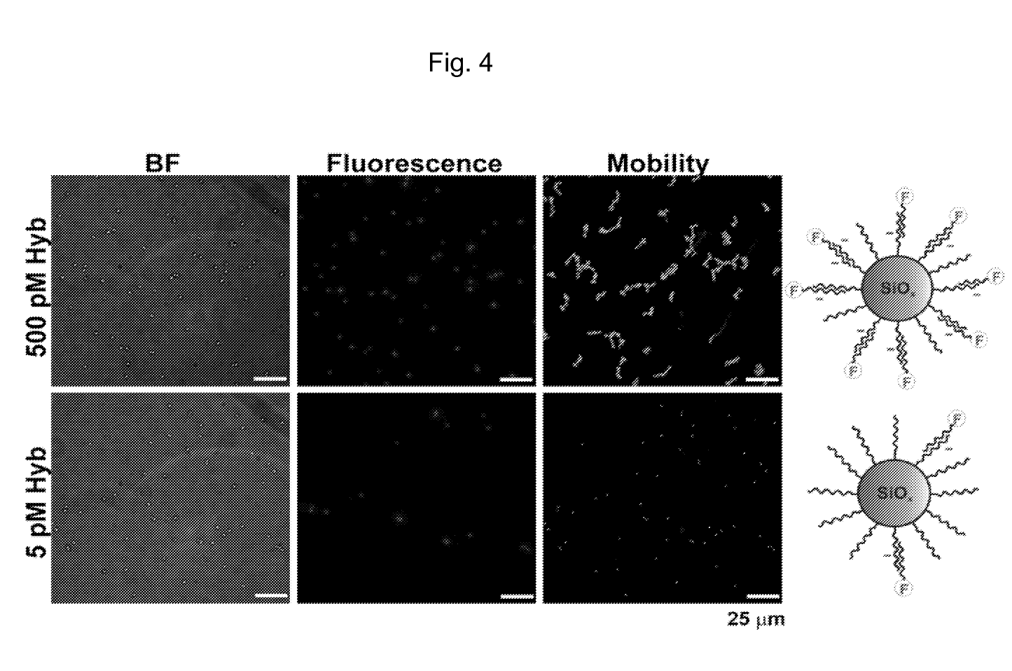

In an embodiment such as in FIGS. 3 and 5-7, where the reference surface is a particle, the reference surface can be a charged particle. The charged reference particle can be either positively or negatively charged, have different geometries such as spherical, rod shaped, triangular, or cubic and be of various sizes that range from 1 nm to 200 μm. Charged reference particles again can be comprised of materials such as silica, polymers, metals, metal oxides, or semiconductors.

In the present method, sensing the charges or charged materials displayed on the capture surface is performed with a reference surface. The reference surface is provided having known, predicted and/or calculated charge densities. In one embodiment, charge densities at various spots on a substrate are detected electrostatically and compared to those of known reference responses. Thus, the local electrostatic interaction of each particle can be used to sense the local surface charge density at any particular loci. In various embodiments, the local electrostatic interaction of each particle can be used to quantitatively determine local surface charge densities.

In another embodiment, the capture surface further comprises a capture molecule or capture material attached thereto and displayed on the capture surface. The attached capture molecule or capture material comprising biomolecules such as nucleotides, polynucletides, peptides, polypeptides, proteins, carbohydrates, and polymers, and/or materials such as inorganic sol gels, metals, catalysts, and small molecule libraries. It is contemplated that the capture molecule or capture material is attached to the substrate by any means of attachment including covalent or noncovalent binding, or interaction.

The capture surface can display arrays or patterns of capture molecules or materials. In one embodiment, the capture surface displays arrays and patterns of biomolecules. For example, the capture surface can be a planar microarray surface comprising multiple oligonucleotides attached to the planar substrate. In another embodiment, the capture surface is a particle having various carbohydrates attached to the particle.

Thus, a method comprising the steps of: a) providing a capture surface displaying capture molecules or materials and a charged reference surface, wherein one of the charged reference surface or the capture surface is a planar substrate and the other is a particle; b) applying the capture surface together with the charged reference surface, such that they are allowed to electrostatically interact; and c) determining the positions and motions of the particles relative to the planar substrate at a specific loci to determine the charge density at said loci.

Sensing the charge of capture molecules displayed can permit the sensing and detection of interactions involving the capture molecule with the surrounding environment. In one embodiment, the binding of an analyte to a capture molecule can be detected by the present method for sensing charges on the capture surface by sensing change in surface charge density.

Thus, in a further embodiment, an assay for detecting the presence of an analyte in a sample, the assay comprising the steps of: a) providing a capture surface displaying capture molecules or materials and a charged reference surface, wherein one of the charged reference surface or the capture surface is a planar substrate and the other is a particle; b) providing a solution suspected of containing an analyte that binds to a specific one of said capture molecules or materials displayed on the capture surface, c) contacting said solution with the capture surface and allowing said binding to occur; d) applying the capture surface and charged reference surface, such that the charged reference surface is allowed to interact with the capture surface; f) characterizing the capture surface electrostatically by examining the positions, motions and/or presence of the particles relative to the planar substrate; and g) determining the presence of the analyte, wherein a change in the charge density of the capture surface indicates that an analyte is present in said sample and bound to said substrate.

In some embodiments, the capture molecules displayed on the capture surface comprise a ligand having known or suspected properties of interaction with an analyte. Such ligands often are molecules having a specific binding partner that can be used as a tag, include, but are not limited to, antibodies, enzymes, antigens, sugars, saccharides, small molecules, amino and polar groups, peptides, proteins, lipoproteins, glycoproteins, enzymes, receptors, channels, and biomolecules. Upon binding an analyte (e.g., enzyme substrate, receptor ligand, antigen, or other protein), a change in the charge density of the capture surface occurs, resulting in a detectable binding event.

The analyte of interest may be nucleic acid molecules, proteins, peptides, haptens, metal ions, drugs, metabolites, pesticide or pollutant. The method can be used to detect the presence of such analytes as toxins, hormones, enzymes, lectins, proteins, signaling molecules, inorganic or organic molecules, antibodies, contaminants, viruses, bacteria, other pathogenic organisms, idiotopes or other cell surface markers. It is intended that the present method can be used to detect the presence or absence of an analyte of interest in a sample suspected of containing the analyte of interest.

In some embodiments, the target analyte is comprised of a nucleic acid and the specific binding complement is an oligonucleotide. Alternatively, the target analyte is a protein or hapten and the specific binding complement is an antibody comprising a monoclonal or polyclonal antibody. Alternatively, the target analyte is a sequence from a genomic DNA sample and the specific binding complement are oligonucleotides, the oligonucleotides having a sequence that is complementary to at least a portion of the genomic sequence. The genomic DNA may be eukaryotic, bacterial, fungal or viral DNA.

In one embodiment, detection of a particular cytokine can be used for diagnosis of cancer. Specific analytes of interest include cytokines, such as IL-2. Cytokines are important analytes of interest in that cytokines play a central role in the regulation of hematopoiesis; mediating the differentiation, migration, activation and proliferation of phenotypically diverse cells. Improved detection limits of cytokines will allow for earlier and more accurate diagnosis and treatments of cancers and immunodeficiency-related diseases and lead to an increased understanding of cytokine-related diseases and biology, because cytokines are signature biomarkers when humans are infected by foreign antigens.

Chemokines are another important class of analytes of interest. Chemokines are released from a wide variety of cells in response to bacterial infection, viruses and agents that cause physical damage such as silica or the urate crystals. They function mainly as chemoattractants for leukocytes, recruiting monocytes, neutrophils and other effector cells from the blood to sites of infection or damage. They can be released by many different cell types and serve to guide cells involved in innate immunity and also the lymphocytes of the adaptive immune system. Thus, improved detection limits of chemokines will allow for earlier and more accurate diagnosis and treatments, i.e. for bacterial infections and viral infections.

In some embodiments, the target analyte may be a variety of pathogenic organisms including, but not limited to, sialic acid to detect HIV, Chlamydia, Neisseria meningitides, Streptococcus suis, Salmonella, mumps, newcastle, and various viruses, including reovirus, sendai virus, and myxovirus; and 9-OAC sialic acid to detect coronavirus, encephalomyelitis virus, and rotavirus; non-sialic acid glycoproteins to detect cytomegalovirus and measles virus; CD4, vasoactive intestinal peptide, and peptide T to detect HIV; epidermal growth factor to detect vaccinia; acetylcholine receptor to detect rabies; Cd3 complement receptor to detect Epstein-Barr virus; β-adrenergic receptor to detect reovirus; ICAM-1, N-CAM, and myelin-associated glycoprotein MAb to detect rhinovirus; polio virus receptor to detect polio virus; fibroblast growth factor receptor to detect herpes virus; oligomannose to detect Escherichia coli; ganglioside G_{M1} to detect Neisseria meningitides; and antibodies to detect a broad variety of pathogens (e.g., Neisseria gonorrhoeae, V. vulnificus, V. parahaemolyticus, V. cholerae, and V. alginolyticus).

In some embodiments, multiple analytes of interest can be detected by utilizing multiple ligands specific to different analytes of interest and utilizing multiple elements or ligands (e.g., barcode oligonucleotides or sugars) corresponding to each analyte of interest.

The analyte of interest may be found directly in a sample such as a body fluid from a host. The host may be a mammal, reptile, bird, amphibian, fish, or insect. In a preferred embodiment, the host is a human. The body fluid can be, for example, urine, blood, plasma, serum, saliva, semen, stool, sputum, cerebral spinal fluid, tears, mucus, pus, phlegm, and the like. The particles can be mixed with live cells or samples containing live cells.

Where the sample is live cells or samples containing live cells, a cell surface protein or other molecule may serve as the analyte of interest. This allows for the detection of cell activation and proliferation events, cellular interactions, multiplexing, and other physiologically relevant events.

In some embodiments the capture surface is a substrate such as in a test strip, microarray or microfluidic device.

In other embodiments, wherein the planar surface is the reference surface, a kit provided comprising a reference surface and/or particles, along with instructions to carry out a method comprising, for example, the following steps: mixing or contacting a sample with particles, spreading the particles on the reference surface, rinsing then measuring the density of particles on the surface. Readout can be carried out using the user's own or a provided device to measure light scattering intensity or on microfluidic device.

The apparatus and methods described herein are capable of parallel electrostatic sampling of a substrate over centimeter length scales, which is the largest area quantitatively imaged by electrostatics to date.

In another embodiment, the invention comprises an assay based on or such as those described in the Examples. Examples 1-3 describe assays which build on this sensing method. The assays include surface-based methods for detecting specific molecular interactions involving (but not limited to) DNA, proteins, carbohydrates, polymers, inorganic sol gels, metals, catalysts, and small molecules.

For example, in one particular embodiment, a sensitive and label-free electrostatic readout of DNA or RNA hybridization in a microarray format. In one embodiment, hybridization is measured electrostatically using a monolayer of gravitationally sedimented silica microspheres that respond to changes in surface charge density (FIG. 1a). Complementary oligonucleotide binding strongly increases surface charge density due to the negatively charged DNA phosphate backbone. As a result, sedimented silica microspheres will levitate over negatively charged areas adopting an equilibrium height that is determined by a balance between gravity and the local electrostatic repulsion. Precise height measurements are used to quantitatively infer the local surface charge density (FIG. 1a). Semi-quantitative readouts of particle height provide a useful alternative for low-cost clinical applications. Thus, the electrostatic charge of the phosphate backbone provides an intrinsic label, eliminating the need for a chemically coupled reporter group such as a fluorophore. The role of each silica microsphere is analogous to that of an electrostatic force microscope (EFM) tip where the vertical deflection of the tip is used to report local electrostatic surface properties. EFM, however, is a serial technique practically limited to a field of view of 100 μm². (Barken, K. B., Haagensen, J. A. J. & Tolker-Nielsen, T. Advances in nucleic acid-based diagnostics of bacterial infections. Clinica Chimica Acta 384, 1-11 (2007); Sinensky, A. K. & Belcher, A. M. Label-free and high-resolution protein//DNA nanoarray analysis using Kelvin probe force microscopy. Nat Nano 2, 653-659 (2007); Butt, H. J., Capella, B. & Kappl, M. Force measurements with the atomic force microscope: Technique, interpretation and applications. Surface Science Reports 59, 1-152 (2005)). The technique described here is capable of parallel electrostatic sampling of a microarray surface over centimeter length scales, which is the largest area quantitatively imaged by electrostatics to date. This label-free approach is compatible with conventional fluorescence readout as well as unconventional arrays fabricated on injection-molded plastic or embedded within microfluidic architectures.

Thus, in one embodiment, an assay for detecting a nucleotide or polypeptide in a sample, the assay comprising the steps of: a) providing a capture surface displaying capture sequences and a charged reference surface, wherein one of the charged reference surface or the capture surface is a planar substrate and the other is a particle; b) providing a solution suspected of containing a nucleotide or polypeptide to be detected that binds specifically to one of said capture sequences displayed on the capture surface, c) contacting said solution with the capture surface and allowing said binding to occur; d) applying the capture surface and charged reference surface, such that the two surfaces are allowed to electrostatically interact; e) determining the positions and/or motions of the charged particles relative to the planar substrate to sense the electrostatic properties of the capture surface; and f) determining the presence of the nucleotide or polypeptide, wherein a change in the charge density of the capture surface indicates that the nucleotide or polypeptide is present in said sample and bound to said substrate.

Due to non-linear screening interactions in aqueous environments, charged microparticles are responsive to a limited range of surface charge densities. At experimental conditions, the range is ˜10 to 10⁶ e/μm². It was found that the charge density of hybridized spots must be tuned within this optimal range in order for the presently described assay to sensitively measure changes in charge density due to hybridization. The most sensitive charge density measurements are achieved when a probe spot transitions from neutrality to a net negative or positive charge upon hybridization. Therefore, the goal of charge tuning is to adjust tuning conditions such that we find the isoelectric point of the capture surface, e.g., single stranded DNA spots. In one embodiment, this is achieved by positively biasing the reference surface, e.g., glass support, by chemical modification, which balances the negative charge contributed by both the charged reference surface and the capture molecules. In one embodiment when the assay is performed on a microarray, charge saturation may occur before 10⁶ e/μm² and a more preferred range can be ˜10 to 10³ e/μm². However, in embodiments which rely on using the ζ potential, such as in Example 5, which uses electrophoresis to measure the particle velocity and trajectory, higher charge densities can be detected.

Other methods to tune the charge density to the range of ˜10 to 10⁶ e/μm² include but are not limited to, tailoring the reaction time, adjusting the concentration of the reference surface modification reagent, the buffer pH, employing a series of pH-controlled rinses to change the charge density of the surface and to also amplify the differences between specific spots and reference probe spots, controlling exposure to the air and oxidation, optimizing the microarray print concentration, analyze and implement blocking reactions and conditions. Examples of such tuning are described infra (See Example 4).

In one embodiment, the reference surface is a silica microsphere which is responsive to surface charge densities from 10 to 10⁶ e/μm². To achieve this, the charge of the glass support is positively biased using an aminosilane modification, which balances the negative charge contributed by both the glass surface and the printed ssDNA molecules (FIG. 1A, and FIG. 3A). Substrates are rendered thiol-reactive using a heterofunctional crosslinking reagent, and an oligoethylene glycol surface functionalization is used to minimize non-specific adsorption. The printed concentrations of ssDNA probes are empirically optimized to be most sensitive to a specific range of analyte concentrations, by examining the apparent bias of spots as a function of print concentration across a dilution series.

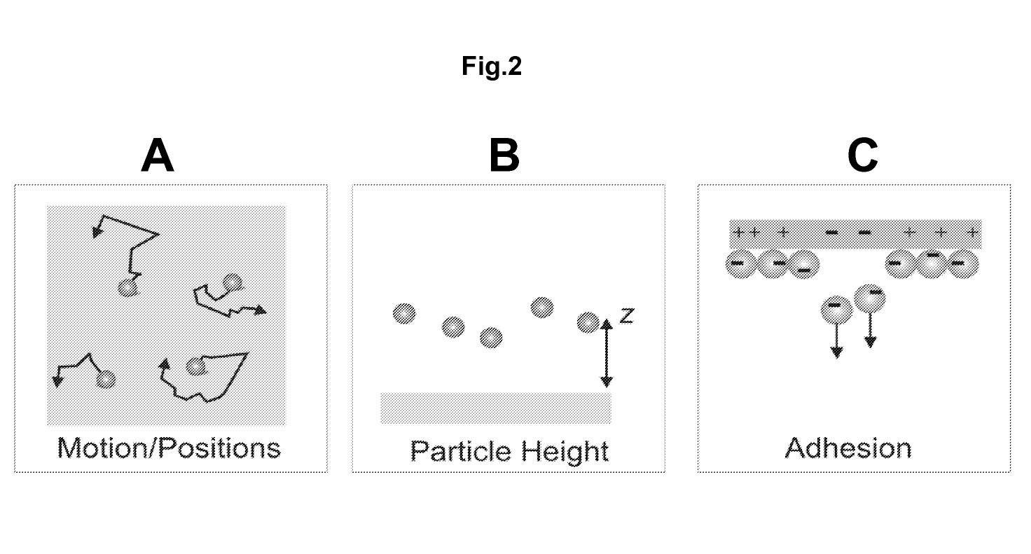

Sensing the charges or charged materials displayed on the capture surface in the present invention can be performed in any number of ways as determined by one having skill in the art. For example, imaging of the capture surface can be performed by interferometery, brightfield microscopy, darkfield microscopy, surface plasmon microscopy, confocal microscopy, total internal reflection microscopy, epifluorescence microscopy or by the naked eye. Imaging can be performed to view the particles statically, or determining their motions and positions two- or three-dimensionally (FIG. 2A).

In one embodiment, three-dimensional particle tracking is used for electrostatic sensing. Surface charge density can be quantitatively determined using an electrostatic model to interpret the heights of microspheres above the array. In order for this approach to succeed, the three-dimensional position of particles must be determined over the capture surface. Various methods are known in the art and described briefly herein. Three-dimensional multiparticle tracking has been demonstrated using confocal microscopy, total internal reflection microscopy (TIRM) Prieve, D. Measurement of colloidal forces with TIRM. Advances in Colloid and Interface Science 82, 93-125 (1999), and reflection interference contrast microscopy (RICM) (Clack, N. G. & Groves, J. T. Many-particle tracking with nanometer resolution in three dimensions by reflection interference contrast microscopy. Langmuir 21, 6430-6435 (2005)). RICM was used in the Examples because it facilitates determination of the absolute separation distance between the microarray surface and individual particles with 5 nm resolution without complications due to closely neighboring particles. A caveat of RICM is that image contrast is generated using a single wavelength according to the phase of interfering rays; absolute phase information has been lost introducing ambiguity into height measurements (Schilling, J., Sengupta, K., Goennenwein, S., Bausch, A. R. & Sackmann, E. Absolute interfacial distance measurements by dual-wavelength reflection interference contrast microscopy. Physical review. E, Statistical, nonlinear, and soft matter physics 69, 021901 (2004)). To overcome this problem, dual wavelength RICM was developed as described in Schilling, J., Sengupta, K., Goennenwein, S., Bausch, A. R. & Sackmann, E. Absolute interfacial distance measurements by dual-wavelength reflection interference contrast microscopy. Physical review. E, Statistical, nonlinear, and soft matter physics 69, 021901 (2004) which is hereby incorporated by reference). Recently, we introduced a RICM-based method capable of localizing the three dimensional positions of a population of microspheres using an image correlation technique (Clack, N. G. & Groves, J. T. Many-particle tracking with nanometer resolution in three dimensions by reflection interference contrast microscopy. Langmuir 21, 6430-6435 (2005)). By adapting this methodology to the analysis of dual wavelength RICM images, the absolute three-dimensional particle positions can be determined unambiguously.

In another example, as shown in FIG. 2C, using adhesion assays to sense the electrostatic properties of the surface. The presence of particles on the surface indicates that there is an electrostatic attraction between the capture and reference surfaces. The absence of particles indicates that the substrate is sufficiently charged as to repel the particles. For example, where the capture surface is the planar substrate, the absence of particles indicates that the capture substrate is sufficiently charged as to repel the reference particles. This adhesion assay provides a straightforward approach to sensing the charge density of the capture surface.

In another embodiment, small molecules and/or molecular interactions and reactions on a surface can be detected by measuring the charge density of a capture surface relative to a reference surface. Molecular interactions and reactions, such as those between an analyte and a ligand, can be measured electrostatically on a surface, for example, using a monolayer of gravitationally sedimented micro- or nanoparticles that respond to changes in surface charge density. As shown in FIG. 2B, in response to interactions and reactions which change surface charge density, sedimented micro- or nanoparticles will levitate over oppositely charged areas adopting an equilibrium height that is determined by a balance between gravity and the local electrostatic repulsion. In one embodiment, height measurements are used to quantitatively infer the local surface charge density. Thus, changes in height measurements can thereby infer if molecular interaction or reaction have occurred resulting in a change in surface charge density.

This label-free approach is compatible with conventional fluorescence readout as well as unconventional arrays fabricated on injection-molded plastic or embedded within microfluidic architectures. Thus, in one embodiment, an apparatus or kit comprising a capture surface and a reference surface, wherein either the capture surface is a planar substrate and the reference surface is a particle.

In another embodiment, electrostatic-based sensing of an analyte bound to a capture surface is described. The capture surface in the form of a colloidal particle may use several techniques that have been developed to detect the surface potential and charge density of colloidal particles. These well-established techniques, including electrophoresis, dynamic light scattering, and phase analysis light scattering are able to sensitively detect the surface charge density of colloidal particle in aqueous or organic solutions by monitoring migrations of particles in the applied electric fields. It was found that these techniques when applied to the electrostatic detection of interactions between a particle and a target analyte bound result in an electrostatic readout with high sensitivity. In one embodiment, capture molecules to capture the target analyte are attached to the colloidal particle capture surface.

Thus, the present methods provide in one embodiment, a method for detecting the presence of an analyte in a sample, comprising the steps of: a) providing a capture surface displaying capture molecules or materials, wherein the capture surface is a particle; b) providing a solution suspected of containing an analyte that binds to a specific one of said capture molecules or materials displayed on the capture surface, c) contacting said solution with the capture surface and allowing said binding to occur; d) applying an electric field to the capture surface, such that the capture surface migrates in the electric field; and e) determining the positions and motions of the particles under the electric field at a specific loci to determine the charge density at said loci.

In a preferred embodiment, a reference surface can be provided. The reference surface can be any substrate which allows fluid or aqueous control of the capture surface, including but not limited to such substrates as a microfluidic channel, a glass slide, or a multi-well growth plate. In such embodiments, it may be preferred that the reference surface also allows easy application of the electric fields.

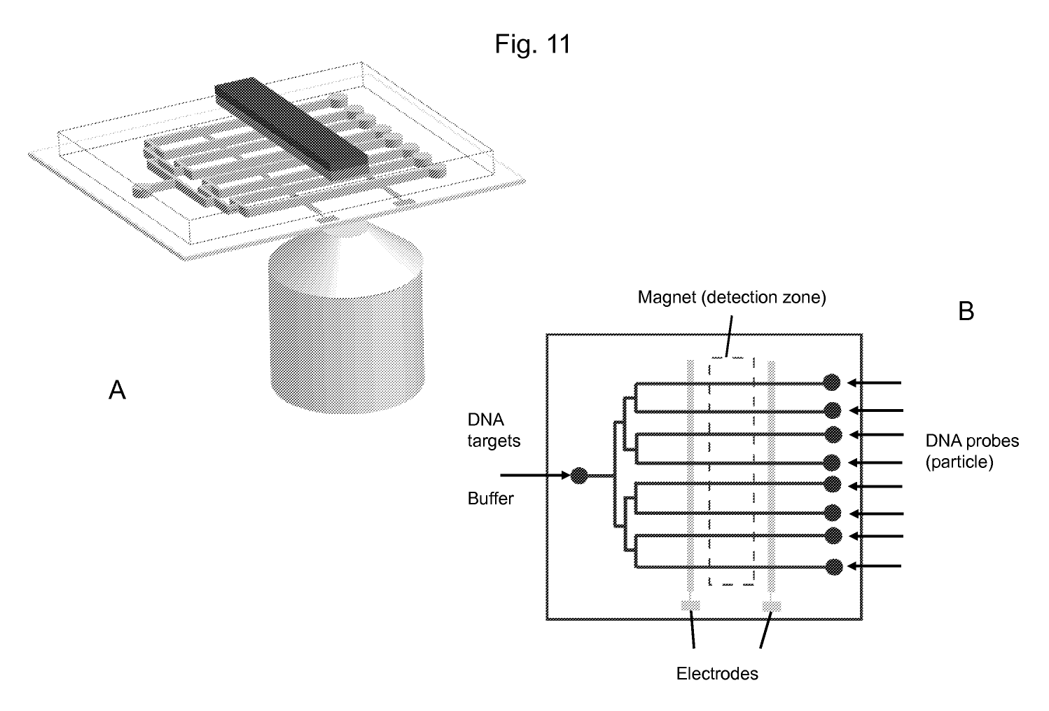

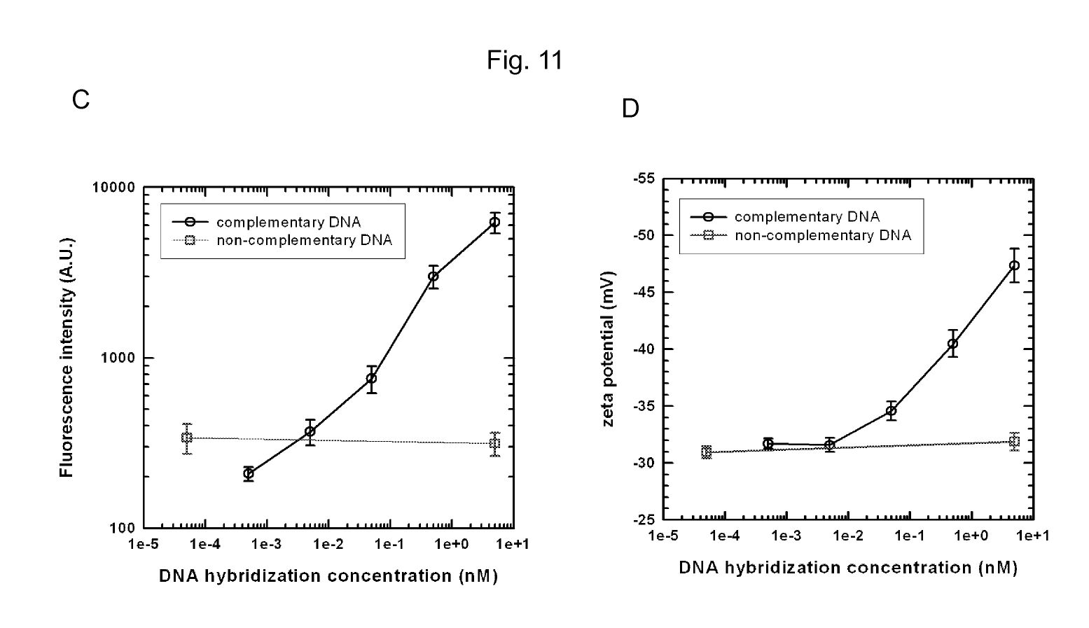

Referring now to FIG. 11, in one embodiment, the capture surface is a magnetic microparticle having capture molecules attached to the particle and the reference surface is a microfluidic channel on a microfluidic device. The embodiment can further comprise a magnet used to hold the magnetic microparticles in place while the capture sequences are allowed to hybridize to the target. An electric field is then applied to measure the surface charge density of particles after hybridizations. In one embodiment, the electric field is generated by electrodes patterned on the substrate. The migration of particles in the channel can be detected by conventional optical microscopy using a 20× magnification objectives and CCD camera while the particle trajectories are analyzed using image analysis software as described infra.

Thus, in another embodiment, a microfluidic device, comprising: a) a microfluidic channel patterned on a substrate, b) magnetic capture particles disposed in said microfluidic channel, wherein said capture particles displaying capture molecules which can bind to a target, c) a magnet placed on the top of said channel to hold the capture particles in the detection zone of said microfluidic channel, d) electrodes patterned on the substrate such that the electrodes are in contact with the microfluidic channel and connected to a power source for applying an electric field to the capture surface, such that the capture surface migrates in the electric field; and e) imaging means for determining the positions and motions of the particles under the electric field at a specific loci to determine the charge density at said loci.

The microfluidic device can be fabricated in different material and using various methods as known in the art. For example, microfluidic devices made from silicon and glass can be fabricated by photolithography and associated technology that has successfully developed in silicon microelectronic. Another fabrication technique is cast molding process using polymer material, such as PDMS (polydimethylsiloxane). Master molds can be either polymer molds fabricated with photolithography or metal molds fabricated with machinery. Another fabrication technique creates microfluidic channel using laser scriber to machine PMMA (poly(methyl methacrylate)) substrate. The microfluidic channel can have different geometry, such as cylinder, triangular, and rectangular and sizes that range from 10 μm to 500 μm wide and 10 μm to 100 μm deep.

Two major techniques, electrophoresis and electroacoustic spectroscopy, have been developed in order to measure surface potential (or surface charge) of microparticles. In electrophoresis, the motion of microparticles in the applied electric filed can be linked to surface charges by appropriate colloidal theories, such as Smoluchowski equation. Different techniques have been developed to monitor the motion of particles in applied electric fields. For example, microelectrophoresis directly images the motion of micron size particle using conventional microscope. Another example, electrophoretic light scattering observe the velocity of particle based on dynamic light scattering technique that has been commercialized to detect the surface potential of particle range from 5 nm to micron size. (e.g. Brookhaven Instruments Corp. and Malvern Instruments Ltd). On the other hand, electroacoustic spectroscopy detect the electric field generated by the displacements of microparticles in the solutions which induced by ultrasound. Electroacoustic spectroscopy has also been commercialized to accurately detect the surface charge of particles in concentrate system.(e.g. HORIBA Instruments, Inc.).

In another embodiment, computer-implemented methods and computer software are described to carry out the presently described methods. Such computer-implemented methods can be made to enable one to locate the three-dimensional position or the XYZ position for each particle with nanometer precision. In one embodiment, the method used to track the particles on a substrate is that described by some of the inventors in Clack, N. G. & Groves, J. T. Many-particle tracking with nanometer resolution in three dimensions by reflection interference contrast microscopy. Langmuir 21, 6430-6435 (2005), hereby incorporated by reference in its entirety.

In another embodiment, a method for sensing the electrostatic properties of a surface comprising: (a) providing a substrate having particles distributed on the substrate; (b) collecting an image of each particle at a specific location on said substrate; (c) measuring in said image a value, position or a multi-dimensional position of each particle in the specific location to determine the local surface property of the particle on the substrate; (d) translating said particle values or positions into an image which shows the local surface property of each particle in the specific location.

Furthermore, to detect a hybridization or binding event or the presence of an analyte, the method may further require the acquisition of a “before” image and an “after” image and a step to subtract or compare the data gathered in the after image from the before images. Thus, in another embodiment, a method for sensing a change in charge surface properties of a surface, further comprising the steps of: (e) providing a reference image wherein the charge surface density of a reference surface is measured; and (f) measuring the change in the measured charge surface density of the particles from the reference surface. The electrostatic interaction between the particle and substrate is determined using electrostatic surface properties for each location over different areas of the surface. In another embodiment, the change in the surface charge density is correlated to the presence of an analyte or a material in a solution and the calculated difference is outputted either by generating an image or an output.

An image (e.g., RICM image) of each particle is collected. A single image or multiple images of each particle is acquired by any custom or standard device.

After image acquisition, the images are interpreted such that a specific signal or value of each particle's interaction with the substrate is measured. In one example, the height of individual particles is measured for all particles. The height is the distance that the particle levitates from the substrate. The height can be measured as the distance from the edge of the particle to the substrate. In other embodiments, the signal or value is the measured position and/or motion of the particle relative to the substrate.

The measured values for each particle are collected and translated into an image of the substrate and particles, such as the images shown in FIG. 3B to 3F. This would provide the XY position and signal measurement for each particle.

Further image processing is known in the art and various methods can be employed. We describe in the examples one method. In some embodiments this determination is made by comparing each image with images of a reference surface or to images found in a precomputed library of images, such as a reference library of interferograms or a kernel library. In other embodiments, this comparison step also matches the collected image to a library image to measure the most probable three-dimensional position of the particle as compared to the surface and/or to other particles.

Average local surface properties are determined by measuring particle values or properties over different areas of the surface. The measured value of the particles in a specific region of the surface can be averaged and interpreted according to an electrostatic model to measure the local surface charge. Repeating this for regions covering the surface produces an image of local surface properties. Equilibrium or reference measurements can be used to infer surface charge density. This may require a model of the electrostatic repulsion between the substrate and particle.

In one embodiment, average local surface properties are determined by measuring particle heights over different areas of the surface. For example, the height of particles above a square region of the surface can be averaged and interpreted according to an electrostatic model to measure the local surface charge. Repeating this for regions covering the surface produces an image of local surface properties. In one embodiment, surface charge density can be quantitatively determined using an electrostatic model to interpret the heights of microspheres above the array. The equilibrium height of each levitated particle is determined by the balance between gravity and electrostatic forces. Over the range of separation distances observed here (50-500 nm), both van der Waals forces and the variation in DNA orientation and structure contribute negligibly to measured heights.²⁴ Therefore, equilibrium height measurements can be used to infer surface charge density. Herein is a model of the electrostatic repulsion between the substrate and particle. Assuming constant potential boundary conditions and using the Derjaguin approximation, which is valid when the ion clouds surrounding the charged surfaces do not significantly overlap (i.e. κ⁻¹<<h),²⁴ yields

$${U}_{el} = 64 π a {ɛɛ}_{o} tan h ( \frac{e {ψ}_{probe}}{4 {k}_{b} T} ) tan h ( \frac{e {ψ}_{substrate}}{4 {k}_{b} T} ) {( \frac{{k}_{b} T}{e} )}^{2} exp ( - κ h ) \qquad [ 1 ]$$

for the electrostatic interaction energy, Uₑₗ, between a sphere of radius a and surface potential, ψ_{probe}, at a height, h, above a substrate with surface potential ψ_{substrate}, in a 1:1 electrolyte at temperature T and dielectric permittivity εε₀.²⁵ The permittivity in vacuum is ε₀ and e is the charge of an electron. Assuming the only other significant force acting vertically on microspheres is gravity, Eq. [1] may be used to relate the equilibrium microsphere height, h, to ψ_{substrate} given a value of ψ_{probe}.^{22,26} Additionally, the Graham equation provides a relation between the surface charge density and surface potential at ionic strength, I:

$$σ ( {ψ}_{substrate} ) = 2 \sqrt{2 {ɛɛ}_{o} {k}_{b} {TIN}_{A}} sin h ( \frac{e {ψ}_{substrate}}{2 {k}_{b} T} ) \qquad [ 2 ]$$

where N_{A} is Avogadro's number.²⁴ Together, Eqs. [1] and [2] provide a scheme for inferring surface charge density from the equilibrium height.²⁷

In the method, particles such as bare silica microspheres are used because an extensive literature exists describing the titration of silica surfaces, enabling the calculation of ψ_{probe} under a range of conditions. See Behrens, S. H. & Grier, D. G. The charge of glass and silica surfaces. Journal of Chemical Physics 115, 6716-6721 (2001), herein incorporated by reference in its entirety. To verify the accuracy of this method, the equilibrium heights of microspheres were measured over a range of ionic strengths. Ionic strength, in these experiments, is determined by controlled addition of NaCl to a solution of deionized water that has equilibrated with atmospheric CO₂. At room temperature, dissolved CO₂ is expected to add 10 μM to the ionic strength at the measured pH of 5.3 according to equilibrium calculations. (Carroll, J. J. & Mather, A. E. The system carbon dioxide-water and the Krichevsky-Kasarnovsky equation. Journal of Solution Chemistry 21, 607-621 (1992); Lide, D. R. CRC handbook of chemistry and physics, (CRC Press, Boca Raton, Fla., 1997)). Results observed and described in the examples are consistent with these expectations.

The present methods can employ various types of particles. One may need to create a library of charges and reference values for other types of particles under a range of conditions similar to that described in Behrens, et al., Journal of Chemical Physics 115, 6716-6721 (2001), herein incorporated by reference.

In another embodiment, a system for sensing electrostatic properties of a surface, the system comprising: (a) an image collector and storage configured to collect and store a plurality of images of a substrate; (b) a value translator that translates the images into a collection of multi-dimensional data of the particles found on the substrate; (c) a model of the electrostatic interaction between the substrate and particle configured to interpret said multi-dimensional data of the particles, calculate the interaction of the particles with the substrate and to provide an interaction value; and (d) an image generator configured to take the interaction values and generate an image of the substrate.

To sense the electrostatic properties of a capture surface; and determine the presence of the nucleotide or polypeptide, wherein a change in the charge density of the capture surface indicates that the nucleotide or polypeptide is present in said sample and bound to said substrate. In another embodiment wherein the system is further used to sense changes on a surface, the system further comprising: (e) a property measurement function which performs a comparison between the multi-dimensional data or the interaction values and the reference data or reference interaction values to determine a change in local surface property between the substrate and/or the particle; and (f) an output device configured to output the change in local surface property as an electrostatic readout of the substrate and/or the particles found in a specific grid location.

Three dimensional particle tracking, as described herein, is useful over a single and multiple locations. In another embodiment, a large area scanning allows you to image and scan over a large area to screen multiple locations simultaneously. In one embodiment, an automated acquisition protocol for RICM imaging of a microarray is carried out by computer implemented software or attached to the imaging systems comprising a translation stage equipped with a linear encoder for translating the sample with nanometer precision over an imaged area. At each location, an autofocus routine is used to ensure reproducible focusing by optimizing the similarity of control points located at the edge of the field diaphragm shadow. After autofocusing, a set number of images (e.g., 10, 20, 40, etc.) are acquired. The frame rate is chosen to ensure the vertical fluctuations of particles are uncorrelated from frame to frame. In one embodiment, the 3D positions of each particle are inputted to the system and a charge density map is generated. An example of a charge density is shown in the gray scale map in FIG. 3D. Thus, for each XYZ position the charge density is then calculated and an output detailing such data can be extracted.

Any imaging method where the appearance of a particle is height dependent is appropriate for use in the present methods. Thus, in one embodiment, interferometry techniques, such as optical coherence tomography, which are capable of high-resolution imaging of large fields of view³⁰ and are more rapid the conventional fluorescence scanning of surfaces, can be used. Interference pattern of light (reflectance from the surface and reflectance off the bottom of the particle) is unique to each particle height. The best fitting interferogram is determined by an algorithm which uses an imaging theory to render predicted images. In another embodiment, brightfield microscopy techniques may be employed. A suitable method can be, for example, (a) shine light above the sample and the shadow cast by particles is height dependent (b) numerically compute expected images and use these reference values to estimate height. In another example, the point spread function of a 100 nm particle is height-dependent and can be interpreted using the same framework outlined above.

It may be preferred to use a transparent capture or reference planar surface to enable imaging from below. In other embodiments, where the planar surface is not transparent, measurement of height of a particle from the surface can be measured from the top down view. For example, interferometry can be carried out from a top down view as is known in the art, e.g., Tomographic phase microscopy (See Choi, W. et al. Tomographic phase microscopy. Nat Meth 4, 717-719 (2007) and Mark E. Brezinski, Optical coherence tomography: principles and applications, Academic Press, 2006, for descriptions of optical coherence tomography.

In a typical experiment, a substrate is mounted in a well-chamber and hybridized. After rinsing, a suspension of silica microspheres is added, and the microspheres are allowed to sediment into a sub-monolayer above the array. FIG. 1b shows a fluorescence image of a representative spot after hybridization of Cy3-A′ (see Table 1 and 2 for sequences). Note that fluorescence labeling is not required, and that target DNA strands are only labeled for comparison. Sedimented microspheres distribute evenly across the entire surface (FIG. 3C). Microspheres adsorb to the positively charged background, but over sufficiently negatively charged areas they remain levitated and laterally mobile. These areas can be distinguished by measuring the intensity variance in a time series of brightfield images (FIG. 3F), or by darkfield images of the substrate after it is inverted to allow weakly adhered beads to (FIG. 3E) or by darkfield microscopy of microspheres that remain adhered after agitating the surface to identify positively charged regions (FIG. 3G).

To electrostatically image a microarray, a collection of dual wavelength RICM images (FIG. 3F) were acquired covering the full array area. These images were used to measure the 3D position of each microsphere with nanometer precision. Images were acquired by scanning the substrate laterally in 30 μm increments using a translation stage and refocusing at each position using a software-driven autofocus routine. At each point, 20 images were acquired (0.4 fps) yielding roughly 20,000 images/mm². On average, there were 20 microspheres per field of view resulting in 400,000 observations/mm².

A surface charge density map is generated by compiling the set of three-dimensional position measurements. The imaged area is divided into a grid of 15 μm squares, and the median height of particles was used to calculate the surface charge density within each square. FIG. 1g shows such a charge density map along with the particle positions used to calculate the charge density in each square. The dashed line indicates the spot perimeter as determined by fluorescence (FIG. 3B). In principle, the difference in surface charge density before and after hybridization can be used to directly measure the density of dsDNA.

### EXAMPLE 1

### Electrostatic Response Using a Microarray

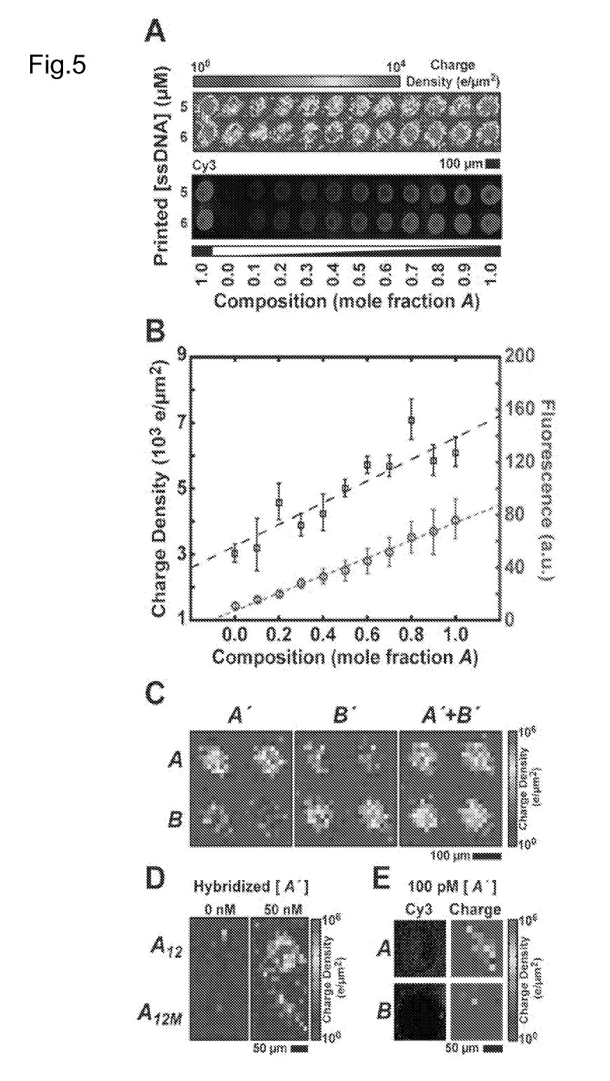

To examine the electrostatic response across a range of DNA densities, a series of spots was printed with binary mixtures formed from ratios of A and B on a microarray (FIG. 5A). In each series, the total ssDNA density was maintained while linearly adjusting the mole fraction of A from 0 to 1. Since both A and B strands are electrostatically and sterically identical, the hybridization efficiency at each spot remains constant. (Peterson, A., Heaton, R. & Georgiadis, R. The effect of surface probe density on DNA hybridization. Nucleic Acids Research 29, 5163-5168 (2001)). Therefore, after hybridization, the density of A′ is linearly related to the density of A strands at each spot, and the total DNA density varies linearly.

The charge density map of two of these series, printed with total ssDNA concentrations of 5 and 6 μM respectively, show a gradual increase in charge density as a function of the mol fraction of A (FIG. 5A). The charge density corresponds with fluorescence intensities and appears to double as the mol fraction of A changes from 0 to 1 (FIG. 5B). This agrees with results listed in the literature for comparable systems. (Ibid., and Zhang, J. et al. Rapid and label-free nanomechanical detection of biomarker transcripts in human RNA. Nature nanotechnology 1, 214-220 (2006); and Fritz, J., Cooper, E., Gaudet, S., Sorger, P. K. & Manalis, S. R. Electronic detection of DNA by its intrinsic molecular charge. Proceedings of the National Academy of Sciences of the United States of America 99, 14142 (2002)).

To evaluate the specificity of this approach, a 2×2 array of A and B spots was generated and examined electrostatically. Specific changes due to hybridization are observed by measuring the change in the electrostatic response of the array (FIG. 5). Non-complementary spots were only mildly charged (150 e/μm²) (FIG. 5C). Hybridization with 50 nM A′, 50 nM B′, or both resulted in a specific increase in charge density (3×10³ e/μm²) of the complementary spots relative to the non-complementary spots (FIG. 5C). To investigate the selectivity of this approach, probe spots of A and A_{M} DNA (Table 1) differing by a single-base mismatch were exposed to 50 nM A′ analyte for 20 minutes. Each of these spots can be distinguished electrostatically (FIG. 2D), which is particularly important for applications such as single nucleotide polymorphism (SNP) profiling. Additionally, by increasing the hybridization time to 24 hr., as little as 50 pM A′ could be distinguished from background signal (FIG. 2E). In our hands, this is the limit of detection, which is only an order of magnitude less sensitive than confocal scanning fluorescence microscopy.

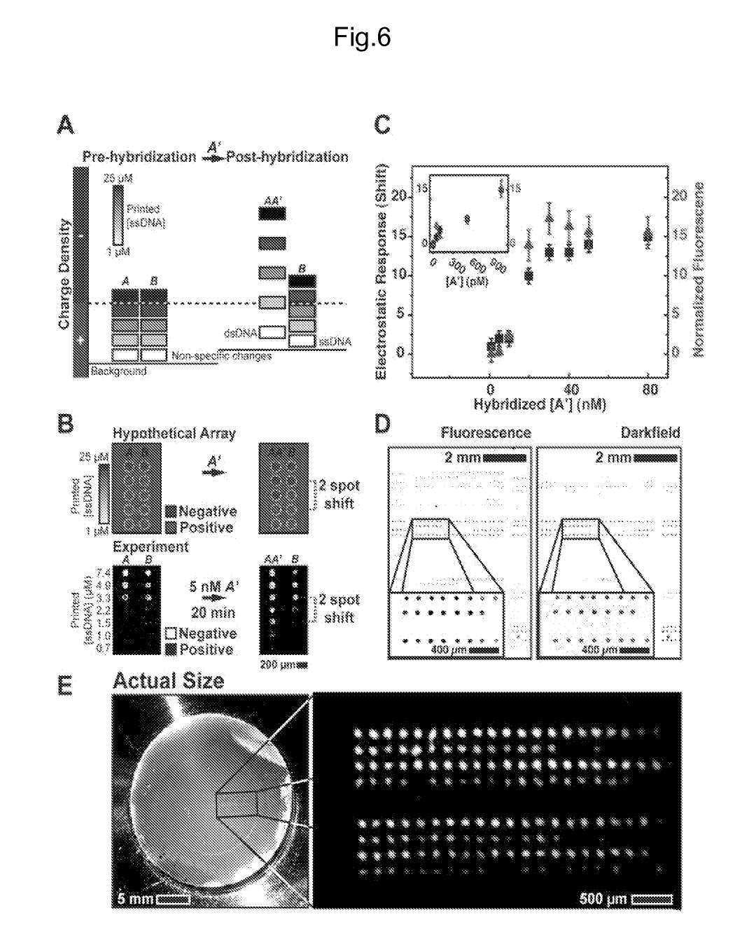

Based on these results, a simplified electrostatic readout can be designed using electrostatically assembled colloidal patterns. (McCarty, L. S., Winkleman, A. & Whitesides, G. M. Electrostatic self-assembly of polystyrene microspheres by using chemically directed contact electrification. Angewandte Chemie (International ed.) 46, 206-209 (2007)). By printing a ladder of ssDNA densities, changes in surface charge density can be imaged as a shift in where spots in the ladder cross from having a net positive charge to a net negative one (FIG. 6A). Hybridization causes an electrostatic change in the ladder identifiable by where negatively charged silica microspheres electrostatically adsorb to the substrate (FIG. 6B). Since silica microspheres strongly scatter light, the resulting colloidal patterns can be imaged without the need for complex or expensive instrumentation to quantify binding (FIG. 6C). Results indicate that a detection limit of 50 pM and a dynamic range extending over 3 orders of magnitude can be obtained by studying the resulting colloidal patterns (FIG. 6C). State-of-the-art fluorescence readout for microarrays using confocal scanners has been reported to achieve sensitivities of 1-5 pM and to have a dynamic range extending over 3 orders of magnitude [www.affymetrix.com]. Nonetheless, direct comparison of fluorescence signal to electrostatic signal on the same substrates, under identical hybridization and imaging conditions reveals similar figures of merit. The 50 pM detection limit observed here is not absolute since it is possible to further improve the fluorescence signal and potentially the electrostatic signal by optimizing array fabrication and hybridization.

The following describe the Materials and Methods used in the above described experiment.

Microarrays. Oligonucleotide microarrays were generated using a conventional robotic spotter to deposit ssDNA on activated glass coverglass. Substrates were prepared by etching 15 minutes in piranha (1:3 30% H₂O₂:H₂SO₄), washing 6 times in ultrapure (80 MΩ/cm) water, and 3 times in neat ethanol. Substrates were then functionalized with aminopropyltrimethoxysilane (APTMS, Fluka >97%) by incubation in a 2% (by vol.) ethanol solution for 1 hr. Subsequently, substrates were extensively rinsed with ethanol, dried under a stream of N₂, and baked at 80° C. for 1 hr. Finally, substrates were activated with succinimidyl-4-(N-maleimidomethyl)cyclohexane-1-carboxylate (SMCC, Pierce) by incubating in a 2 mg/ml DMSO solution overnight.

Microarrays were generated by a robotic arrayer (Functional Genomics Facility, Univ. Calif., Berkeley) with silicon microcontact printing pins (Parallel Synthesis, Santa Clara, Calif.). After printing, substrates were passivated against non-specific DNA adsorption by incubating substrates in a 2 mg/ml 11-mercaptoundecyl-hexa(ethylene glycol) (PEG-SH) DMSO solution overnight. Finally, substrates were washed and rinsed in ethanol, dried with a N₂ stream and stored under dry N₂ until final use.

Oligonucleotides. Probe sequences (Table 1) were purchased from Integrated DNA Technologies (HPLC-purified). All Hybridizations were performed in 1×SSC solution where the analyte DNA was heat to ˜70 C.° and unless otherwise note hybridization time was limited to 20 min. After hybridization, microarrays were rinsed with 50 ml 1×SSC followed by a rinse with 50 ml deionized (18.1 MΩ/cm) water. The print concentrations ranged from 25 μM down to 0.5 μM. Similar results were obtained by immobilizing ssDNA on aminosilane treated coverglass with UV crosslinking (300 mJ/cm²).

TABLE 1
Oligonucleotide probe and target design

| SEQ ID | Sequence | | |
|---|---|---|---|
| NO: | Symbol | Sequence (5′-3′) | Description |
| 1 | A | SH-PEG₁₈-TAC CAC | Capture sequence |
| | | ATC ATC CAT ATA | complementary to Hepatitis B |
| | | ACT GAA AGC CAA | Virus (HBV) target |
| 2 | B | SH-PEG₁₈-TGC ATC | Capture sequence |
| | | CAG GTC ATG TTA | complementary to HIV target |
| | | TTC CAA ATA TCT | |
| 3 | Cy3-A′ | Cy3-TTG GCT TTC | HBV target |
| | | AGT TAT ATG GAT | |
| | | GAT GTG GTA | |
| 4 | Cy3-B′ | Cy3-AGA AGA TAT | HIV target |
| | | TTG GAA TAA CAT | |
| | | GAC CTG GAT | |
| 5 | A₁₂ | SH-PEG₁₈-TAC CAC | 12 mer capture sequence |
| | | ATC ATC | complementary to HBV |
| 6 | A_{12M} | SH-PEG₁₈-TAC CAA | 12 mer capture sequence |
| | | ATC ATC | complementary to HBV with |
| | | | single base mismatch |
| 7 | Cy3-A′₁₂ | Cy3-TAT GAT GTG | 12 mer HBV target |
| | | GTA | |
| 8 | ALD | NH₂-GTG ATC CCA | Sequence complementary to |
| | | GTG ACA GCG GGG | human aldolase A |
| | | GGC A | |
| 9 | MARS | NH₂-TAT TAT GTC | Sequence complementary to |
| | | AGA TGT GCA AAT | human methionine-tRNA |
| | | TCT T | synthetase |
| 10 | poly(A) | NH₂-AAA AAA AAA | poly(A) control sequence |
| | | AAA AAA AAA AAA | |
| | | AAA A | |

Microarray Imaging. Silica particles (Bangs Labs, Fischers, Ind.) with diameters that ranged from 5.68 μm to 0.97 μm were used for imaging. To collect darkfield images silica particles were allowed to sediment onto the surface of the microarray. The substrate was subsequently inverted for a period of 10 minutes and then a 4× objective was used to collect darkfield images of the substrate. The scattering from 2.34 μm diameter silica particles was sufficiently intense that a cell phone could be used to image a side-illuminated microarray through a 30× pen microscope. To collect variance data, 2.34 μm silica particles were allowed to sediment for ˜30 min, and then particle positions were measured by collecting time-lapse video for a total of 30 seconds. The variance in these images was used to distinguish between laterally mobile and immobile silica particles.

RICM. Dual wavelength RICM was performed using a Nikon TE-2000 inverted fluorescence microscope fitted with a 100× plan apo oil immersion objective (NA 1.3). Sample illumination was provided by a mercury arc lamp and filtered using a dual-band pass (460-480 nm and 510-550 nm) excitation filter (Chroma, Rockingham, Vt.). The aperture diaphragm was set to provide a small illumination numerical aperture (INA 0.496) and, hence, minimal angular variation in the incident light. This is important for maximizing the contrast between interference fringes. The field diaphragm was partially closed to facilitate reproducible focusing on the coverslip-water interface. Reflected light was imaged onto separate halves of a single CCD camera (Quantix 57, Roper Scientific, Dowington, Pa.) using a DualView (Optical Insights LLC, Tucson, Ariz.) image splitter interposed between the body of the microscope and the camera.

Microspheres imaged by dual wavelength RICM produce interferograms that depend on the particle height and the illumination wavelength regardless of the presence of neighboring microspheres (FIG. 3E). The height of an individual microsphere is estimated by correlating interferograms from respective color channels with interferograms calculated according to an image formation theory. The absolute height is determined by finding the pair of correlation maxima that coincide across each color channel. Image pairs lacking unique agreement correspond to malformed or partially imaged particles and are excluded from further analysis. Lateral positions within an image are measured independently in each color channel by image correlation. By accounting for the lateral location where the image was acquired, microspheres across the entire array could be localized. A distributed image processing framework was developed that allowed processing of datasets to generate 3-D particle positions using a flexible number of workstations as each application demanded.

Large Area Scanning. The acquisition protocol for RICM imaging of a microarray involved several steps that were automated using Matlab together with μManager (found at μManager website (micro-manager)). An ASI-MS2000 translation stage equipped with a linear encoder was used for translating the sample with 200 nm precision over the imaged area. At each location, an autofocus routine was used to ensure reproducible focusing by optimizing the similarity of control points located at the edge of the field diaphragm shadow. After autofocusing, 40 images were acquired at a rate of 0.4 Hz. The frame rate was chosen to ensure the vertical fluctuations of beads were uncorrelated from frame to frame.

Expression Profiling. Both breast adenocarcinoma (MCF-7) poly(A) RNA and RNA fragmentation reagents were acquired from Ambion (Austin, Tex.). RNA fragmentation was performed according to the manufacturer's instructions to 60-200 bp. All hybridizations were performed with 100 ng of RNA in 30 μl of 1×SSC buffer heated to 60 C°. Probe sequences used for expression profiling were obtained from Affymetrix (Palo Alto, Calif.).

### EXAMPLE 2

### Multiplexing Electrostatic Response Using Microarray

To demonstrate that this method is truly massively parallel and can be used to readout conventional microarrays, DNA spots were printed on a standard 1″×3″ glass microscope slide at a density >1000 spots/cm². Arrays were imaged after hybridizing with 50 nM Cy3-B′ over a 1 sq. in. area by fluorescence and dark field scattering from electrostatically adsorbed 2.34 μm-diameter silica microspheres. Both fluorescence and dark field (negative contrast) images reveal specific hybridization to complimentary spots (FIG. 6D).

### EXAMPLE 3

### Electrostatic Readout in Gene Expression Profiling

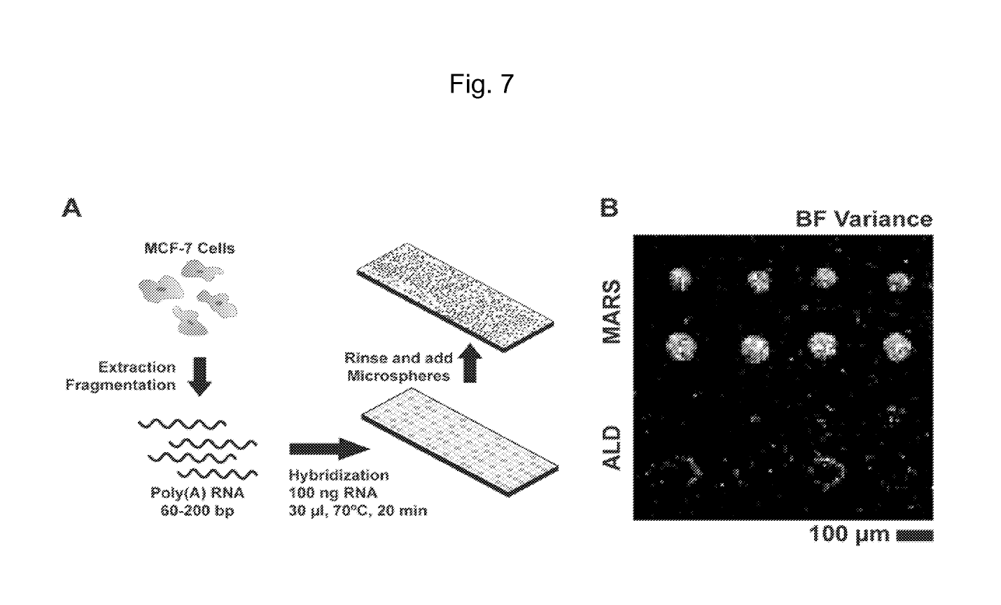

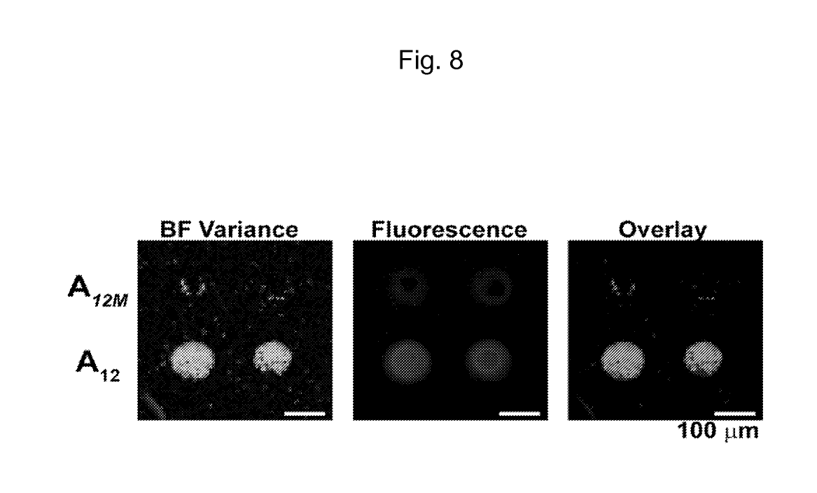

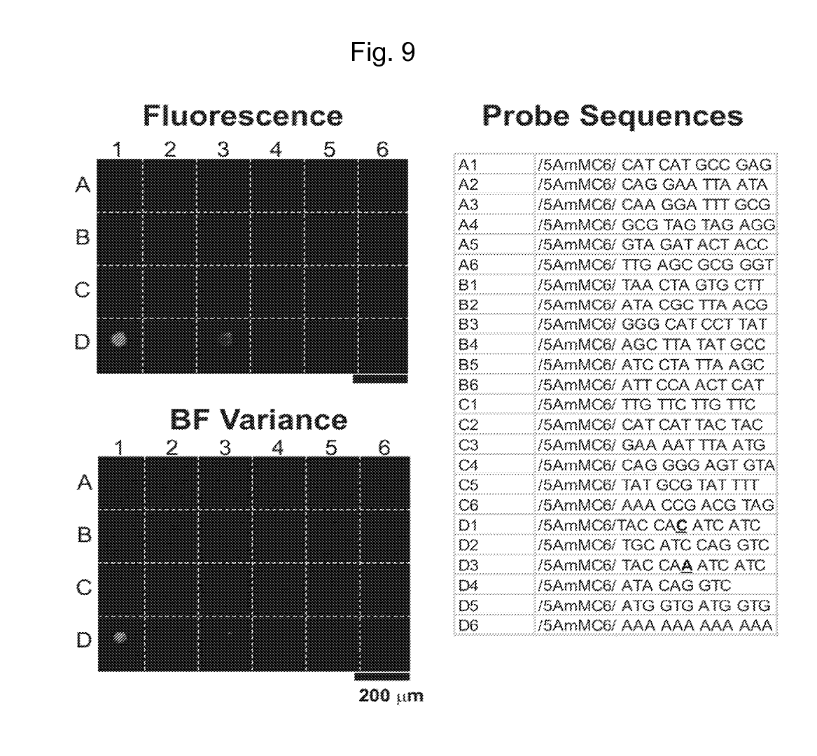

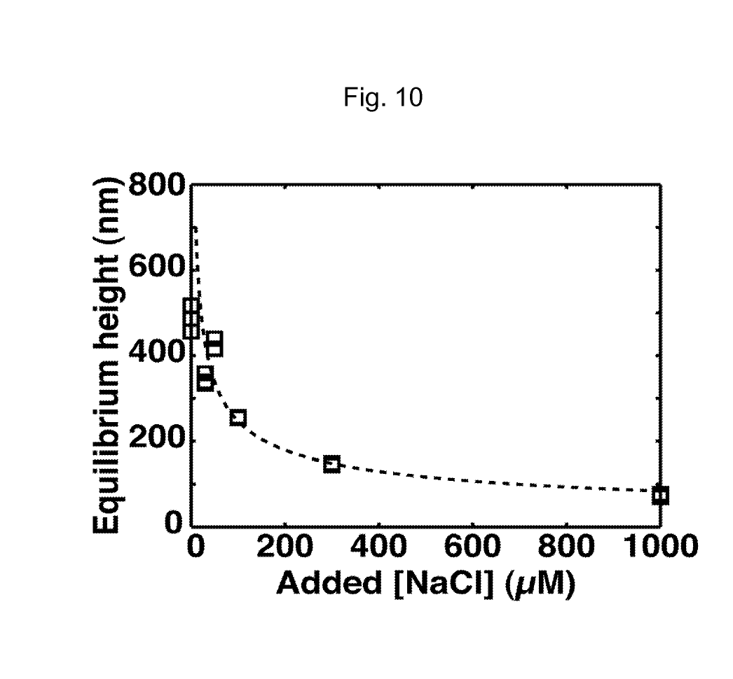

Since gene expression profiling is the most widely implemented application of DNA microarray technology, it is important to demonstrate that electrostatic readout can be applied to physiological samples with complex background. To demonstrate this we focused on detection of the human β-actin mRNA in purified but unamplified poly(A)-RNA extracted from human breast adenocarcinoma (MCF-7) cells. The β-actin housekeeping gene served as a positive control to demonstrate a specific transcript could be identified in the complex background of cellular mRNA. Prior to measurements, the unamplified poly(A)-RNA was randomly fragmented to 60-200 bp in length to better match probe lengths, and hybridizations were performed for 20 min. with 50 ng of RNA in 30 μl of 1×SSC heated to 60° C. (FIG. 7A). Dark field imaging of arrays interrogated with 2.34 μm diameter silica spheres indicates the electrostatic response of the β-actin probe spot relative to two control spots after hybridization (FIG. 7B). Each control sequence was chosen to minimize hybridization with sequences in the human genome. These experiments demonstrate that a specific transcript can be identified in the complex mixture of total cellular RNA without amplification. Although Gerber et al. recently used microcantilever array sensors to demonstrate label-free detection of cellular RNA, this technology cannot be multiplexed to the level of conventional microarrays because of the difficulties in microfabrication, chemical modification, and integration of a large number of cantilevers (Zhang, J. et al. Rapid and label-free nanomechanical detection of biomarker transcripts in human RNA. Nature nanotechnology 1, 214-220 (2006).).

In conclusion, we have demonstrated a fundamentally new approach to microarray readout with several advantages. First, because millions of microspheres are simultaneously sampling the entire substrate, throughput is only limited by the field of view of the imaging system. Interferometry techniques, such as optical coherence tomography, are capable of high-resolution imaging of large fields of view (Huang, D. et al. Optical Coherence Tomography. Science 254, 1178-1181 (1991)). and are more rapid the conventional fluorescence scanning of surfaces. Second, the majority of biomolecules are inherently charged and therefore electrostatic-based detection should be broadly applicable to a variety of molecules or macromolecules deposited in microarray format. Third, by detecting patterns of electrostatically assembled colloidal particles, interrogation can be rapidly performed without the use of complex instrumentation. Patterns of strongly scattering colloidal particles can be imaged with low-power, low-magnification systems such a magnifying glass. This points toward a straightforward approach towards developing rapid, portable, point-of-care, label-free microarray diagnostics.

### EXAMPLE 4

### Tuning the Charge Density of the Microarray

The most sensitive charge density measurements are achieved when a single stranded DNA probe spot transitions from neutrality to a net negative charge upon hybridization and the charge density of the hybridized spot is ˜10 to 10⁶ e/μm². Therefore, the goal of charge tuning is to adjust conditions such that we find the isoelectric point of single stranded DNA spots. This is achieved by positively biasing the glass support using an aminosilane modification, which balances the negative charge contributed by both the glass surface and the printed ssDNA molecules. The description below highlights the experimental conditions used to tune surface charge. The rationale for charge tuning is that the charge density of a spot is not exclusively the result of the charge of the DNA phosphate backbone (PO₄⁻). At all times, the measure surface charge density is due to the charge of a) the oligonucleotides immobilized onto the microarray chip, b) the crosslinking reagent that covalently couples the DNA to the surface, and c) the intrinsic surface charge density of the glass slide.

The terminal hydroxy group on the supporting silica surface can become deprotonated when placed in contact with water (SiOH [symbol] SiO⁻+H⁺ pKa˜7.5). Therefore, the microarray support is intrinsically negatively charged and any additional DNA printed on the slide will further increase the negative charge of the surface. In order to “tune” the charge density of the DNA microarray and target a surface that is neutrally charged, we tested a suite of DNA-crosslinking reagents and strategies. Aldehyde coupling by Schiff base addition, mercaptosilane functionalization and activation with crosslinking reagents, and reactive epoxy coupling to terminal amines all produced undesirable results because DNA microarrays were always net negatively charged. The most successful implementation of this strategy was achieved when the glass slides were functionalized with an amino silane reagent (aminopropyltrimethoxy silane or aminopropyltriethoxy silane), that was then activated with a heterofunctional crosslinking reagent that links terminal thiols to amines. The terminal amine groups on the glass surface can be protonated when the substrates are placed under aqueous conditions (R—NH₃⁺ [symbol] R—NH₂+H⁻ pKa˜9.5).

Reaction time. Very rarely do reactions on the surface of the microarray achieve a 100% yield. Therefore, there will always remain a fraction of unreacted primary amines and silanol groups that contribute to the net charge. In addition, silane reactions will also generate multilayer structures. That means that that aminopropyl trimethoxy silane reaction with the glass surface can generate a dense network of amine groups that give additional positive charge to the microarray surface. Importantly, the yield of these reactions can be adjusted by tailoring the reaction time and concentration of the aminosilane reagent. For example, we found that a 90 min reaction with 1% (by volume) aminopropyltrimethoxysilane reagent gave a significantly more positively charged microarray surface compared to the surface activated for 30 min.

Buffer pH. The bulk pH of the buffer can change the effective charge density of the surface. A range of buffer pH's were tested in experiments. Typically a pH of 7.2 was used, but in some cases SSC buffer with a pH of 6.5, or Tris buffer to a pH of 8-8.5 was also used.

Buffer history. We also found that buffers used to rinse the DNA microarray could change the measured charge density. For example, if a microarray is briefly rinsed with 0.1 M HCl and then placed in buffer then the surface would be rendered highly positively charged. Similarly, a brief 0.1 M NaOH rinse would leave the surface highly negatively charge even when the microarray was returned to buffer at pH 7. This hysteresis has been previously reported and characterized using X-ray photoelectron spectroscopy for amine-modified silica surfaces. We take advantage of this, and employed a series of pH-controlled rinses to change the charge density of the surface and to also amplify the differences between our specific spots and reference probe spots. Importantly, the measured charge density remained stable over a period of a several days under buffer. Storing microarray samples in air rendered the surface negatively charged due to some unknown reactions. To avoid this issue, samples were stored under a nitrogen atmosphere which maintained their apparent surface potential for extended periods of time (weeks to months).

Print concentration. The print concentration of ssDNA dictates the final DNA surface density within each spot. The optimal print concentration of ssDNA probes with the greatest sensitivity was determined by measuring the charge of each spot across a dilution series of spots. The range of print concentration was also dictated by the degree of positive charge on the microarray surface. Typical print concentration ranged from ˜μM to over 25 μM. Typically, the density of DNA in the spot was saturated when the DNA spot concentration exceeded ˜20 μM.

Blocking. Another important parameter in implementing the assay was the development of high-quality blocking in order to a) minimize the number of reactive maleimide groups that can ultimately hydrolyze and alter the charge of the surface, b) minimize non-specific adsorption of target DNA, and c) not alter the intrinsic charge density of the microarray surface. Through a complete analysis of blocking reactions and conditions we have identified N-hydroxysuccinimide methyl-capped ethylene oxide reagent (Methyl-PEO₁₂-NHS ester, Pierce, USA), at a 1 mM concentration in DMSO as providing optimum blocking against non-specific DNA adsorption. Many of the commonly used blocking reagents and conditions available in the literature are not compatible with electrostatic based detection. For example, a 1% solution (by mass) bovine serum albumin (BSA) is commonly used to block against non-specific DNA adsorption. BSA will indeed minimize the adsorption of oligonucleotides to the surface of the microarray, however, BSA displays an isoelectric point of 4.7. Thus BSA adsorption will alter the surface potential of the microarray. Another common problem with commercial reagents is the use of anionic surfactant such as SDS which may change the charge density of the microarrays surface. The ethylene glycol blocking reagent is nonionic and ideally suited for electrostatic-based detection.

### EXAMPLE 5

### Electrostatically Sensing DNA Captured on Particle Surface Using Microfluidic Device

In this specific example we aim to demonstrate the feasibility of electrostatic-based sensing when the capture surface is in the form of colloidal particle. To obtain electrostatic readout with high sensitivity, colloidal particles were attached with desired DNA strands and used to capture the target DNA.

The surface potentials of colloidal particles were determined by either dynamic light scattering instrument or electrophoresis in home-built microfluidic channels. By measuring velocities of numerous particles under electric fields via scattering fluctuations of light, the conventional dynamic light scattering technique can sensitively determine the averaged surface charges density of colloidal particles. This well-established technique can also provide a reference to characterize the surface potential obtained by electrophoresis measurement in microfluidic channels.

In microfluidic channel experiments (FIGS. 1a & 11b), particle motions in the applied electric field were monitored by conventional microscope and CCD camera. The trajectories and velocity of particles were analyzed by customized image analysis program, a modified version of the RICM-based method capable of localizing the three dimensional positions of a population of microspheres using an image correlation technique described in Clack, N. G. & Groves, J. T. Many-particle tracking with nanometer resolution in three dimensions by reflection interference contrast microscopy. Langmuir 21, 6430-6435 (2005)). This program was adapted to find the centers of particles, and track the motion of individual particles.

Electrostatic-based readout via microfluidic devices has several advantages: (1) low cost of detection instrumentation; (2) minimal sample volumes are required; (3) the microfluidic setup is reusable; (3) hybridization kinetics are rapid; (4) no robotic spotter is required to print DNA spots.

The following section details the materials and methods used in this proof-of-concept experiment.

Microparticles. ssDNA molecules were either covalently attached on carboxylate-modified polystyrene magnetic particle (Invitrogen, Carlsbad, Calif.) or non-covalently attached on streptavidin-modified polystyrene magnetic particle (Invitrogen, Carlsbad, Calif.) through biotin-streptavidin complex. For covalently linking ssDNA to carboxylate-modified particle, 5 mM EDC (1-ethyl-3-(3-dimethylaminopropyl)carbodiimide) was mixed with particle solutions in 25 mM MES buffer in order to activate the carboxylate group. The activated carboxylate group is then coupled to amine functionalized targets (e.g. amine-terminated DNA or ethanolamine). By changing the ratio of DNA and ethanolamine on particle surfaces, surface charge densities were easily tuned. After surface modification, the particles were washed with 10 mM MES buffer with 0.02% Tween 20. For biotin-streptavidin conjugation, microparticles were washed with B&W buffer (10 mM Tris-HCl (pH=7.6)+1 mM EDTA+2M NaCl). Surface charge densities were modified by altering the compositions of biotinylated DNA, biotin, biotinylated polyethylene glycol on microparticle surface. After surface modification, the particles were washed with B&W buffer.

Oligonucleotides. Probe sequences (Table 2) were purchased from Integrated DNA Technologies (HPLC-purified). All Hybridizations were performed in 5×SSC solution with 0.1% SDS (sodium dodecyl sulfate) at room temperature and hybridization time was limited to 60 mins. After hybridization, microparticles were washed with 5 mM NaCl+5 mM sodium citrate, pH=5.5.

TABLE 2
Oligonucleotide probe and target design

| Sequence | Sequence | | |
|---|---|---|---|
| Number | Symbol | Sequence (5′-3′) | Description |
| 1 | A | NH₂ (or biotin)-PEG₁₈- | Capture sequence |
| | | TAC CAC ATC ATC | complementary to |
| | | CAT ATA ACT GAA | Hepatitis B |
| | | AGC CAA | Virus (HBV) target |
| 3 | Cy3-A′ | Cy3-TTG GCT TTC | HBV target |
| | | AGT TAT ATG GAT | |
| | | GAT GTG GTA | |
| 4 | Cy3-B′ | Cy3-AGA AGA TAT | HIV target |
| | | TTG GAA TAA CAT | |
| | | GAC CTG GAT | |

Surface charges detection 1: Dynamic light scattering measurement. Surface potentials of microparticles were measured by detecting particle migrations in applied electric fields. The conventional dynamic light scattering instrument (Brookhaven, Holtsville, N.Y.) was used to determine the surface charge and potential of microparticle. The DNA particle were hybridized in centrifuge tubes for 1 hr and diluted in the specific buffer. The instrument uses electrophoretic light scattering and the laser doppler velocimetry method to determine particle velocity and the surface potential from its velocity.

Surface charges detection 2: Electrophoresis in microfluidic channel. The home-built microfluidic channels with two patterned electrodes were performed to detect the surface charges of microparticles (FIGS. 11a and 11b). The experiment was performed by following steps: (1) Microfluidic channels were flushed with hybridization buffer. (2) Microparticles with different desired DNA strands were injected into different parallel channels. (3) A magnet was placed on the top of microfluidic channel to hold the particles in the detection zones. (4) After injecting a sufficient number of particles, the magnet was removed and an electric field was applied to detect the surface charge of particles with ssDNA. The migration of particles was detected by conventional optical microscopy using a 20× magnification objectives and CCD camera. The particle trajectories were analyzed using image analysis software. (5) DNA targets were injected into each channel to complete hybridizations. The magnet was placed on the top of the channel in order to hold particles. (6) Microfluidic channels were flushed with buffer to remove excess DNA targets. (7) The magnet was removed again to release particles. The electric field was then applied to measure the surface charge density of particles after hybridizations.

Fabrication of microfluidic device. The mold of microfluidic channel was fabricated by photolithography. The microfluidic channel casts in poly(dimethylsiloxane) (PDMS) (Dow Corning Slygard 184) and attach to a microscope glass slide which has two patterned gold electrodes. A 5 min UV/Ozone pretreatment of PDMS was performed to improve the adhesion.

To investigate the sensitivity and specificity of this approach, the colloidal particles coated with ssDNA A were hybridized with a series of concentrations of target DNA A′ or B′. The specific changes due to hybridization were characterized by measuring the electrostatic response of the capture particles which was benchmarked against the fluorescence response. FIGS. 11c and 11d shows the fluorescence and electrostatic response of particles exposed to complementary and non-complementary oligonucleotides over a range of target concentrations. The fluorescence signal was measured by conventional epifluorescence microscopy. FIGS. 11c & d indicates that the limit of sensitivity for fluorescence is ˜5 pM whereas the electrostatic readout can achieve ˜500 fM sensitivity. Based on the theoretical and experimental considerations, it may be possible to achieve higher sensitivity by changing the surface charge density to reduce the non-specific adsorption of non-complementary DNA.

The above examples are provided to illustrate the invention but not to limit its scope. Other variants of the invention will be readily apparent to one of ordinary skill in the art and are encompassed by the appended claims. All publications, databases, and patents cited herein are hereby incorporated by reference for all purposes.

What is claimed is:

1. A method for electrostatically sensing charges or charged materials, comprising the steps of (a) providing a capture surface having charges or charged materials to be detected displayed on said capture surface, (b) providing a reference surface having a reference charge density, (c) allowing the capture surface with the charged reference surface to electrostatically interact; and (d) sensing the charge density of the capture surface by comparison to the charge density of the reference surface.

2. The method of claim 1, wherein the capture surface can be of various geometries, including planar, curved, and spherical geometries.

3. The method of claim 1, wherein the reference surface is charged.

4. The method of claim 1, wherein the capture surface is a substantially planar substrate and the reference surface is a particle.

5. The method of claim 1, wherein the reference surface is a charged planar substrate and the capture surface is a particle.

6. The method of claim 1, wherein the capture and reference surfaces can be made from various types and combinations of materials, selected from the group consisting of: any metals, semiconductors, silica, polymers, oxides, fluid interfaces, and biological surfaces.

7. The method of claim 1, wherein if the capture or reference surface is a particle, said particle being any of the following shape, spherical, rod shaped, triangular, or cubic.

8. The method of claim 7, wherein if the capture or reference surface is a particle, said particle having a size that range from 1 nm to 200 μm, preferably 500 nm to 100 μm, 0.5 μm to 10 μm, more preferably 1 μm to 6 μm

9. The method of claim 4, wherein the capture surface is a glass slide and the reference surface is a particle.

10. The method of claim 5, wherein the capture surface is a semiconductor nanocrystal and the reference particle is a metal substrate.

11. The method of claim 3, wherein the reference surface is positively or negatively charged. and is provided having known, predicted and/or calculated charge densities.

12. The method of claim 1, wherein the capture surface further comprises a capture molecule or capture material attached thereto and displayed on the capture surface.

13. The method of claim 12, wherein the attached capture molecule or capture material comprising biomolecules such as nucleotides, polynucletides, peptides, polypeptides, proteins, carbohydrates, and polymers, and/or materials such as inorganic sol gels, metals, catalysts, and small molecule libraries.

14. The method of claim 13, wherein the capture molecule or capture material is attached to the substrate by any means of attachment including covalent or noncovalent binding, or interaction.

15. The method of claim 1, wherein the capture surface is uncharged, or positively or negatively charged.

16. The method of claim 1, wherein step (d) sensing the the charge density of the capture surface is carried out by sensing the capture surface's position or motion relative to the reference surface.

17. The method of claim 16, wherein the step (d) sensing of charge density is carried out by imaging the surface using interferometery, microscopy, darkfield microscopy, surface plasmon microscopy, confocal microscopy, total internal reflection microscopy, epifluorescence microscopy or by the naked eye.

18. The method of 1, wherein the capture surface is tuned such that the capture event of the analyte bound to the substrate and background are distinguished.

19. The method of claim 18, wherein the capture and reference surface are tuned to a total charge density of about 10 to 10⁶ e/μm².

20. A method for detecting charge on a surface, comprising the steps of: a) providing a capture surface displaying capture molecules or materials and a charged reference surface, wherein one of the charged reference surface or the capture surface is a planar substrate and the other is a particle; b) applying the capture surface together with the charged reference surface, such that they are allowed to electrostatically interact; and c) determining the positions and motions of the particles relative to the planar substrate at a specific loci to determine the charge density at said loci.

21. The method of claim 20, wherein the capture and reference surfaces can be made from various types and combinations of materials, including but not limited to, any metals, semiconductors, silica, polymers, oxides, fluid interfaces, and biological surfaces.

22. The method of claim 20, wherein the capture or reference surface as a particle is contemplated having different geometries such as spherical, rod shaped, triangular, or cubic and sizes that range from 1 nm to 200 μm, preferably 500 nm to 100 μm, 0.5 μm to 10 μm, more preferably 1 μm to 6 μm.

25. An assay for detecting the presence of an analyte in a sample, the assay comprising the steps of: a) providing a capture surface displaying capture molecules or materials and a charged reference surface, wherein one of the charged reference surface or the capture surface is a planar substrate and the other is a particle; b) providing a solution suspected of containing an analyte that binds to a specific one of said capture molecules or materials displayed on the capture surface, c) contacting said solution with the capture surface and allowing said binding to occur; d) applying the capture surface and charged reference surface, such that the charged reference surface is allowed to interact with the capture surface; f) characterizing the capture surface electrostatically by examining the positions, motions, and/or presence of the particles relative to the planar substrate; and g) determining the presence of the analyte, wherein a change in the charge density of the capture surface indicates that an analyte is present in said sample and bound to said substrate.

26. The assay of claim 25, wherein the capture surface is tuned such that the capture event of the analyte bound to the substrate and background are distinguished.

27. The assay of claim 26, wherein the capture and reference surface is blocked such that non-specific adsorption is minimized.

28. The assay of claim 25, wherein the charged reference surface is characterized by imaging the surface using interferometery, microscopy, darkfield microscopy, surface plasmon microscopy, confocal microscopy, total internal reflection microscopy, epifluorescence microscopy or by the naked eye.

29. An assay for detecting a nucleotide or polypeptide in a sample, the assay comprising the steps of:
a) providing a capture surface displaying capture sequences and a charged reference surface, wherein one of the charged reference surface or the capture surface is a planar substrate and the other is a particle;
b) providing a solution suspected of containing a nucleotide or polypeptide to be detected that binds specifically to one of said capture sequences displayed on the capture surface,
c) contacting said solution with the capture surface and allowing said binding to occur;
d) applying the capture surface and charged reference surface, such that the two surfaces are allowed to electrostatically interact;
e) determining the positions and/or motions of the charged particles relative to the planar substrate to sense the electrostatic properties of the capture surface; and
f) determining the presence of the nucleotide or polypeptide, wherein a change in the charge density of the capture surface indicates that the nucleotide or polypeptide is present in said sample and bound to said substrate.

30. A microfluidic device, comprising: a) a microfluidic channel patterned on a substrate, b) magnetic capture particles disposed in said microfluidic channel, wherein said capture particles displaying capture molecules which can bind to a target, c) a magnet placed on the top of said channel to hold the capture particles in the detection zone of said microfluidic channel, d) electrodes patterned on the substrate such that the electrodes are in contact with the microfluidic channel and connected to a power source for applying an electric field to the capture surface, such that the capture surface migrates in the electric field; and e) imaging means for determining the positions and motions of the particles under the electric field at a specific loci to determine the charge density at said loci.

31. An assay for detecting a nucleotide or polypeptide in a sample, the assay comprising the steps of: a) providing a capture surface displaying capture sequences, wherein the capture surface is a particle; b) providing a solution suspected of containing a nucleotide or polypeptide to be detected that binds specifically to one of said capture sequences displayed on the capture surface, c) contacting said solution with the capture surface and allowing said binding to occur; d) applying electric field to the capture surface, such that the migration of the captured surface is driven by applied electric field; f) characterizing the capture surface electrostatically by examining the positions, motions, and velocity of migration; and g) determining the presence of the nucleotide or polypeptide, wherein a change in the charge density of the capture surface indicates that the nucleotide or polypeptide is present in said sample and bound to said substrate.

32. A method for detecting the presence of an analyte in a sample, the method comprising the steps of: a) providing a capture surface displaying capture molecules or materials and electric fields, wherein the capture surface is a particle; b) providing a solution suspected of containing an analyte that binds to a specific one of said capture molecules or materials displayed on the capture surface, c) contacting said solution with the capture surface and allowing said binding to occur; d) applying electric field to the capture surface, such that the migration of the captured surface is driven by applied electric field; f) characterizing the capture surface electrostatically by examining the positions, motions, and velocity of migration; and g) determining the presence of the analyte, wherein a change in the charge density of the capture surface indicates that an analyte is present in said sample and bound to said substrate.

33. The method of claim 32, wherein the charged surface is characterized by imaging the particle motion in the electric field using dynamic light scattering, video microscopy, phase analysis light scattering.

34. The method of claim 32, wherein contacting said solution with the capture surface can be performed in microfluidic channel to minimize the required amount of analyte.

35. The method of claim 32, wherein the capture surface is tuned such that the capture event of the analyte bound to the substrate and background are distinguished.

36. The method of claim 32, wherein the capture and reference surface is blocked such that non-specific adsorption is minimized.


SEQUENCE LISTING (34 sequences)

SEQ ID NO: 1 - DNA, 30 bp, Artificial
  Synthetic oligonucleotide capture sequence complementary to Hepatitis B Virus (HBV) target
taccacatcatccatataactgaaagccaa

SEQ ID NO: 2 - DNA, 30 bp, Artificial
  Synthetic oligonucleotide capture sequence complementary to HIV target
tgcatccaggtcatgttattccaaatatct

SEQ ID NO: 3 - DNA, 30 bp, Artificial
  Synthetic oligonucleotide of HBV target
ttggctttcagttatatggatgatgtggta

SEQ ID NO: 4 - DNA, 30 bp, Artificial
  Synthetic oligonucleotide of HIV target
agaagatatttggaataacatgacctggat

SEQ ID NO: 5 - DNA, 12 bp, Artificial
  Synthetic oligonucleotide 12 mer capture sequence complementary to HBV
taccacatcatc

SEQ ID NO: 6 - DNA, 12 bp, Artificial
  Synthetic oligonucleotide 12 mer capture sequence complementary to HBV with single base mismatch
taccaaatcatc

SEQ ID NO: 7 - DNA, 12 bp, Artificial
  Synthetic oligonucleotide 12 mer HBV target
tatgatgtggta

SEQ ID NO: 8 - DNA, 25 bp, Artificial
  Synthetic oligonucleotide sequence complementary to human aldolase A
gtgatcccagtgacagcggggggca

SEQ ID NO: 9 - DNA, 25 bp, Artificial
  Synthetic oligonucleotide sequence complementary to human methionine-tRNA synthetase
tattatgtcagatgtgcaaattctt

SEQ ID NO: 10 - DNA, 25 bp, Artificial
  Synthetic oligonucleotide poly(A) control sequence
aaaaaaaaaaaaaaaaaaaaaaaaa

SEQ ID NO: 11 - DNA, 12 bp, Artificial
  Synthetic oligonucleotide
catcatgccgag

SEQ ID NO: 12 - DNA, 12 bp, Artificial
  Synthetic oligonucleotide
caggaattaata

SEQ ID NO: 13 - DNA, 12 bp, Artificial
  Synthetic oligonucleotide
caaggatttgcg

SEQ ID NO: 14 - DNA, 12 bp, Artificial
  Synthetic oligonucleotide
gcgtagtagagg

SEQ ID NO: 15 - DNA, 12 bp, Artificial
  Synthetic oligonucleotide
gtagatactacc

SEQ ID NO: 16 - DNA, 12 bp, Artificial
  Synthetic oligonucleotide
ttgagcgcgggt

SEQ ID NO: 17 - DNA, 12 bp, Artificial
  Synthetic oligonucleotide
taactagtgctt

SEQ ID NO: 18 - DNA, 12 bp, Artificial
  Synthetic oligonucleotide
atacgcttaacg

SEQ ID NO: 19 - DNA, 12 bp, Artificial
  Synthetic oligonucleotide
gggcatccttat

SEQ ID NO: 20 - DNA, 12 bp, Artificial
  Synthetic oligonucleotide
agcttatatgcc

SEQ ID NO: 21 - DNA, 12 bp, Artificial
  Synthetic oligonucleotide
atcctattaagc

SEQ ID NO: 22 - DNA, 12 bp, Artificial
  Synthetic oligonucleotide
attccaactcat

SEQ ID NO: 23 - DNA, 12 bp, Artificial
  Synthetic oligonucleotide
ttgttcttgttc

SEQ ID NO: 24 - DNA, 12 bp, Artificial
  Synthetic oligonucleotide
catcattactac

SEQ ID NO: 25 - DNA, 12 bp, Artificial
  Synthetic oligonucleotide
gaaaatttaatg

SEQ ID NO: 26 - DNA, 12 bp, Artificial
  Synthetic oligonucleotide
caggggagtgta

SEQ ID NO: 27 - DNA, 12 bp, Artificial
  Synthetic oligonucleotide
tatgcgtatttt

SEQ ID NO: 28 - DNA, 12 bp, Artificial
  Synthetic oligonucleotide
aaaccgacgtag

SEQ ID NO: 29 - DNA, 12 bp, Artificial
  Synthetic oligonucleotide
taccacatcatc

SEQ ID NO: 30 - DNA, 12 bp, Artificial
  Synthetic oligonucleotide
tgcatccaggtc

SEQ ID NO: 31 - DNA, 12 bp, Artificial
  Synthetic oligonucleotide
taccaaatcatc

SEQ ID NO: 32 - DNA, 9 bp, Artificial
  Synthetic oligonucleotide
atacaggtc

SEQ ID NO: 33 - DNA, 12 bp, Artificial
  Synthetic oligonucleotide
atggtgatggtg

SEQ ID NO: 34 - DNA, 12 bp, Artificial
  Synthetic oligonucleotide
aaaaaaaaaaaa